(19) United States
(12) Patent Application Publication
(10) Pub. No.: US 2018/0105135 A1
(43) Pub. Date: Apr. 19, 2018

(54) ENERGY DISSIPATION DEVICE

(71) Applicant: UNIVERSITY OF CANTERBURY, Christchurch (NL)

(72) Inventors: Gavin David KEATS, Christchurch (NZ); Alessandro PALERMO, Christchurch (NZ); Mohammad Mustafa MASHAL, Santa Barbara, CA (US)

(21) Appl. No.: 15/567,256

(22) PCT Filed: Apr. 15, 2016
(86) PCT No.: PCT/NZ2016/050061

§ 371 Date: Oct. 17, 2017

Related U.S. Application Data
(60) Provisional application No. 62/149,199, filed on Apr. 17, 2015.

(51) Int. Cl. B60R 22/28; B62D 1/19; F16F 7/12; F16F 7/116; F16F 15/03

(52) U.S. Cl. CPC B60R 22/28; B62D 1/195; F16F 15/035; F16F 7/116; F16F 7/123

(57) ABSTRACT

An energy dissipation device having a longitudinal axis, with first and second members that are movable longitudinally relative to each other upon an axial load applied along the longitudinal axis of the device. A plurality of U-shaped flexural plates (UFPs) are arranged between the first and second members in the longitudinal direction of the device and operatively attached to the first and second members and configured to flex upon relative movement of the first and second members. An energy dissipation device may have at least one redundant yielding-type energy dissipater connected to one but not both of the first and second members.

### FIELD OF THE INVENTION

This invention relates to an energy dissipation device such as a damper or brace, for use in structures to absorb seismic and/or wind loads.

### BACKGROUND

Dampers, braces, energy dissipaters, or mechanical dissipative fuses are used in structures to limit vibration induced by winds or to dissipate energy generated by seismic events.

Energy dissipaters can be used in different configurations in building and bridge structures. For example, as bracing to provide lateral resistance against wind and/or earthquake loads, or between two adjacent structural members to absorb energy through a vertical shear sliding mechanism.

Many types of metallic and viscous dampers or energy dissipaters are available in the market. Viscous fluid dampers do not experience low-cycle fatigue and can generally accommodate large seismic displacements, but require specialist materials, require specialist manufacturing processes and highly accurate machined parts and end seals, and for these reasons are expensive. Mechanical buckling restrained braces (BRBs) are more affordable than viscous dampers and can accommodate large displacements but after several cycles are susceptible to low cycle fatigue which can lead to failure of the brace. In addition, commonly available dampers tend to be heavy and difficult to repair.

Generally, buckling restrained braces do not have equal force in tension and compression, resulting in a phenomena called ‘overstrength of the brace’. Overstrength behaviour can damage structural members that the BRB is connected to, or adjacent connections. To compensate, the connections and other structural members must incorporate an overstrength factor resulting in bigger sections, which increases the cost. Due to these factors, the manufacturing process of an ideal BRB requires accurate machined parts and special details such as fused length of the bar and end connections, which also contribute to the final cost.

It is an object of at least preferred embodiments of the present invention to address and/or ameliorate at least one or more of the above mentioned disadvantages and/or to at least provide the public with a useful alternative.

In this specification where reference has been made to patent specifications, other external documents, or other sources of information, this is generally for the purpose of providing a context for discussing the features of the invention. Unless specifically stated otherwise, reference to such external documents or such sources of information is not to be construed as an admission that such documents or such sources of information, in any jurisdiction, are prior art or form part of the common general knowledge in the art.

### SUMMARY OF THE INVENTION

A first aspect of the present invention provides an energy dissipation device having a longitudinal axis, the device comprising first and second members that are movable longitudinally relative to each other upon an axial load applied along the longitudinal axis of the device, and a plurality of U-shaped flexural plates (UFPs) arranged between the first and second members in the longitudinal direction of the device and operatively attached to the first and second members and configured to flex upon relative movement of the first and second members.

The UFPs that are operatively attached to the first and second members may be arranged to plastically deform to dissipate energy. In an embodiment, the energy dissipation device further comprises one or more redundant UFPs connected to one but not both of the first and second members. If a loading event causes at least one of the UFPs attached to the first and second members to yield under large axial loads, the redundant UFP(s) can then be connected to the other of the first and second members to restore at least some functionality to the energy dissipation device. Alternatively, redundant UFP(s) can be connected to the other of the first and second members to increase the capacity of the energy dissipation device before an event that causes the UFPs attached to the first and second members to yield.

In an embodiment, the first and second members are substantially parallel or coaxial and are movable parallel and/or axially relative to each other. For example, the first or second member may comprise a square hollow section or rectangular hollow section, with at least a major part of the other of the first and second members positioned in the hollow section.

The energy dissipation device preferably comprises a housing to obscure and protect the UFPs. In one embodiment the housing is provided by the first member, which substantially encloses the second member and the UFPs.

The energy dissipation device may be a self-centring device. In an embodiment, the energy dissipation device comprises a plurality of post-tensioned tendons, wherein the tendons are coupled to the first and second members such that both compressive and tensile axial loads applied to the energy dissipation device tension and/or stretch the tendons. In an embodiment, the tendons are attached to end blocks or end plates that are movable relative to the first and second members, and the first and second members may comprise stops that restrict the direction of movement of the end blocks or end plates relative to the first and/or second member. For example, the stops may restrict inward movement of the end blocks relative to the first and/or second members.

In embodiments having tendons, the tendon post-tension is preferably sufficient to bias the first and second members back towards a neutral position upon release of the axial load applied to the energy dissipation device. The tendons may comprise steel, fibreglass, a memory alloy, or other suitable material.

In a further embodiment, the energy dissipation device may be a multi-performance device, wherein the behaviour of the device varies depending on the magnitude of the axial load. In an embodiment, the energy dissipation device comprises at least one supplementary damper operatively connected to the first member. The supplementary damper(s) may comprise one or more grooved dissipaters, other axial damper(s), or one or more additional UFPs. The energy dissipation device preferably comprises end connectors at opposite ends of the energy dissipation device, for coupling the energy dissipation device to structural members. The end connectors are preferably removably attachable to the structural member to allow installation, removal and/or replacement of the energy dissipation device. The end connectors are preferably adjustable.

In embodiments with supplementary damper(s), the supplementary damper(s) may be attached between the first member and an end connector such that the supplementary damper(s) are in series with the UFPs. Alternatively, the supplementary damper(s) may be attached between the first member and the second member.

The UFPs may all be oriented in the same direction. Alternatively, the UFPs may be oriented in opposing directions. For example, adjacent UFPs may be arranged end-to-end. One such embodiment, particularly for more compact devices, may comprise one or more double UFPs, each comprising a pair of integral, opposed UFPs that form an oblong cross-section. The UFPs that are operatively attached to the first and second members may comprise two or more UFPs nested one inside the other. For example, a smaller radius double UFP nested within a larger radius double UFP. One or more spacers may optionally be positioned between two nested UFPs.

The energy dissipation device may comprise one or more rows of UFPs. In one embodiment, the first member comprises a hollow cross section and the second member is positioned within the hollow of the first member. A first row of UFPs is attached to a first side of the second member and to a first wall of the first member, and a second row of UFPs is attached to an opposite side of the second member and an opposite second wall of the first member. For example, the second member may comprise an I-beam and the UFPs may be bolted or welded to a web of the I-beam. Alternatively, the second member may comprise a hollow section and the UFPs may be bolted or welded to one or more sides of the hollow section.

The energy dissipation device may comprise guides such as bushings between the first and second members to reduce the buckling length of one or both member(s).

The energy dissipation device may be in the form of a strut for use in structures to absorb structural deflections under seismic and/or wind loading.

A second aspect of the present invention provides an energy dissipation device having a longitudinal axis, the device comprising: first and second members that are movable longitudinally relative to each other upon an axial load applied to the device; at least one yielding-type energy dissipater operatively attached to the first and second members and configured to flex upon relative movement of the first and second members; and at least one redundant yielding-type energy dissipater connected to one but not both of the first and second members.

The yielding-type energy dissipaters may be U-shaped flexural plates (UFPs) or alternatively may have other cross sections such as I- or H-shaped cross sections. The yielding-type energy dissipaters preferably comprise a ductile material such as steel or shape-memory alloy, and are plastically deformable to dissipate energy.

In preferred embodiments, if the energy dissipation device is damaged and/or the yielding-type energy dissipater(s) yield under large axial loads, the redundant dissipater(s) can be connected to the other of the first and second members to restore at least some functionality to the energy dissipation device. For example, the redundant dissipater(s) may be boltable to the other of the first and second members, or connectable by any suitable type of fastener.

In an embodiment, the energy dissipation device comprises at least as many redundant energy dissipaters as yielding-type energy dissipaters operatively attached to the first and second members.

The energy dissipation device according the second aspect may further comprise one or more of the features described above in relation to the first aspect.

An energy dissipation device may be used alone, or could be used in combination with other devices for enhanced performance.

The term ‘comprising’ as used in this specification and claims means ‘consisting at least in part of’. When interpreting statements in this specification and claims which include the term ‘comprising’, other features besides the features prefaced by this term in each statement can also be present. Related terms such as ‘comprise’ and ‘comprised’ are to be interpreted in a similar manner.

It is intended that reference to a range of numbers disclosed herein (for example, 1 to 10) also incorporates reference to all rational numbers within that range (for example, 1, 1.1, 2, 3, 3.9, 4, 5, 6, 6.5, 7, 8, 9 and 10) and also any range of rational numbers within that range (for example, 2 to 8, 1.5 to 5.5 and 3.1 to 4.7) and, therefore, all sub-ranges of all ranges expressly disclosed herein are hereby expressly disclosed. These are only examples of what is specifically intended and all possible combinations of numerical values between the lowest value and the highest value enumerated are to be considered to be expressly stated in this application in a similar manner.

This invention may also be said broadly to consist in the parts, elements and features referred to or indicated in the specification of the application, individually or collectively, and any or all combinations of any two or more said parts, elements or features.

To those skilled in the art to which the invention relates, many changes in construction and widely differing embodiments and applications of the invention will suggest themselves without departing from the scope of the invention as defined in the appended claims. The disclosures and the descriptions herein are purely illustrative and are not intended to be in any sense limiting. Where specific integers are mentioned herein which have known equivalents in the art to which this invention relates, such known equivalents are deemed to be incorporated herein as if individually set forth. As used herein the term ‘(s)’ following a noun means the plural and/or singular form of that noun.

As used herein the term ‘and/or’ means ‘and’ or ‘or’, or where the context allows both. The invention consists in the foregoing and also envisages constructions of which the following gives examples only.

### BRIEF DESCRIPTION OF THE DRAWINGS

The present invention will now be described by way of example only and with reference to the accompanying drawings in which:

FIGS. 1(i) to 1(v) show a first embodiment of a brace for seismic damping, where FIG. 1(i) is an external side elevation view of the brace in a neutral position, FIG. 1(ii) is a section view of the brace in a neutral position, FIG. 1(iii) is a section view of the brace extended from the neutral position during a seismic event, FIG. 1(iv) is a section view of the brace compressed from the neutral position during a seismic event, and FIG. 1(v) is a section view of the brace after the seismic event, with some residual displacement;

FIGS. 2(i) to 2(v) show an embodiment of a self-centring brace for seismic damping, where FIG. 2(i) is an external side elevation view of the brace in a neutral position, FIG. 2(ii) is a section view of the brace in a neutral position, FIG. 2(iii) is a section view of the brace extended from the neutral position during a seismic event, FIG. 2(iv) is a section view of the brace compressed from the neutral position during a seismic event, and FIG. 2(v) is a section view of the brace after the seismic event, with no residual displacement;

FIGS. 3(i) to 3(vii) show an embodiment of a multi-performance brace for seismic damping having supplementary dissipaters in the form of external grooved dissipaters, where FIG. 3(i) is an external side elevation view of the brace in a neutral position, FIG. 3(ii) is a section view of the brace in a neutral position, FIG. 3(iii) is a section view of the brace extended during a seismic event, FIG. 3(iv) is a section view of the brace further extended during an extreme seismic event to activate the grooved dissipaters, FIG. 3(v) is a section view of the brace compressed from the neutral position during a seismic event, FIG. 3(vi) is a section view of the brace further compressed during an extreme seismic event to activate the grooved dissipaters, and FIG. 3(vii) is a section view of the brace after the seismic event, with some residual displacement;

FIG. 4 is a section view of the grooved dissipater used in the multi-performance brace of FIGS. 3(i) to 3(vii);

FIGS. 5(i) and 5(ii) are partial section views of two alternative embodiments of the multi-performance brace, where FIG. 5(i) has grooved dissipaters positioned internally, and FIG. 5(ii) has a slotted bolt connection instead of grooved dissipaters;

FIGS. 6(i) to 6(vii) show an alternative embodiment of a multi-performance brace for seismic damping having supplementary dissipaters in the form of double UFPs, where FIG. 6(i) is an external side elevation view of the brace in a neutral position, FIG. 6(ii) is a section view of the brace in a neutral position, FIG. 6(iii) is a section view of the brace extended from the neutral position during a seismic event, FIG. 6(iv) is a section view of the brace further extended during an extreme seismic event to activate the supplementary UFPs, FIG. 6(v) is a section view of the brace compressed from the neutral position during a seismic event, FIG. 6(vi) is a section view of the brace further compressed during an extreme seismic event to activate the supplementary UFPs, and FIG. 6(vii) is a section view of the brace after the seismic event, with some residual displacement;

FIGS. 7(i) to 7(iii) show a supplementary double UFP from the embodiment of FIGS. 6(i) to 6(vii), where FIG. 7(i) is and underside plan view of the UFP, FIG. 7(ii) is a top plan view of the UFP, and FIG. 7(iii) is a side section view of the UFP through two bolts;

FIGS. 8(i) to 8(vii) show an embodiment of a self-centring multi-performance brace for seismic damping with external grooved dissipaters, where FIG. 8(i) is an external side elevation view of the brace in a neutral position, FIG. 8(ii) is a section view of the brace in a neutral position, FIG. 8(iii) is a section view of the brace extended during a seismic event, FIG. 8(iv) is a section view of the brace further extended during an extreme seismic event to engage the grooved dissipaters, FIG. 8(v) is a section view of the brace compressed from the neutral position during a seismic event, FIG. 8(vi) is a section view of the brace further compressed during an extreme seismic event to engage the grooved dissipaters, and FIG. 8(vii) is a section view of the brace after the seismic event, with a small amount of residual displacement due to the grooved dissipaters;

FIGS. 9(i) to 9(v) show a further embodiment device for seismic damping, the device is a mini device for more compact applications, where FIG. 9(i) is an external side elevation view of the device in a neutral position, FIG. 9(ii) is a section view of the device in a neutral position, FIG. 9(iii) is a section view of the device extended from the neutral position during a seismic event, FIG. 9(iv) is a section view of the device compressed from the neutral position during a seismic event, and FIG. 9(v) is a section view of the device after the seismic event, with some residual displacement;

FIG. 10 is a section view of an alternative embodiment mini device with nested double UFPs;

FIGS. 11(i) and 11(ii) are section views of two further alternative embodiment mini devices with nested double UFPs separated by spacers, where FIG. 11(i) has threaded end connectors, and FIG. 11(ii) has boltable end connectors and additionally includes a slotted-bolt friction damper to increase the stroke of the device;

FIGS. 12(i) to 12(iv) show the slotted-bolt friction damper of the embodiment of FIG. 11(ii), where FIG. 12(i) is a top section view taken through the bolt, FIG. 12(ii) is a side view of a outer plate, FIG. 12(iii) is a side view of a brass shim, and FIG. 12(iv) is a side view of the inner loading plate;

FIGS. 13(i) and 13(ii) are views of a U-shaped flexural plate (UFP) used in the embodiments of FIGS. 1(i) to 6(vii), where FIG. 13(i) is a plan view of the UFP, and FIG. 13(ii) is a side view;

FIGS. 14(i) to 14(iii) are views of a double UFP used in the embodiments of FIGS. 9(i) to 9(v), where FIG. 14(i) is an underside plan view of the UFP, FIG. 14(ii) is a side view, and FIG. 14(iii) is a top plan view;

FIG. 15 shows experimental force-displacement hysteresis loops for a prototype UFP brace of FIGS. 1(i) to 1(v);

FIG. 16 shows the backbone curve for the prototype UFP brace corresponding to FIG. 15;

FIG. 17 is a plot showing dissipated energy per cycle and cumulative for the UFP brace corresponding to FIGS. 15 and 16;

FIG. 18 is a plot of corrected area-based hysteretic damping for the UFP brace corresponding to FIGS. 15 to 17;

FIG. 19 shows force-displacement hysteresis loops for a commercially available buckling restrained brace;

FIG. 20 is a graph of experimental force-displacement hysteresis loops for the self-centring UFP brace of FIGS. 2(i) to 2(v) with a low level of initial post-tensioning in the tendons;

FIG. 21 shows the backbone curve for the self-centering UFP bracing dissipater corresponding to FIG. 20;

FIG. 22 is a plot showing Tendon force-drift hysteresis for the self-centering UFP bracing dissipater corresponding to FIGS. 20 and 21;

FIG. 23 is a plot showing dissipated energy per cycle and cumulative dissipated energy for the self-centering UFP bracing dissipater corresponding to FIGS. 20 to 22;

FIG. 24 is a plot showing corrected area-based hysteretic damping for the self-centering UFP bracing dissipater corresponding to FIGS. 20 to 23;

FIGS. 25(i) to 25(iii) are force-displacement plots for a theoretical 7 m long brace, similar to the brace in FIGS. 2(i) to 2(v), with no initial post-tensioning, where FIG. 25(i) shows the force-displacement hysteresis for the UFPs, FIG. 25(ii) shows the force-displacement hysteresis for the tendons, and FIG. 25(iii) shows the combined force-displacement hysteresis for the UFPs and tendons;

FIGS. 26(i) to 26(iii) are force-displacement plots for the theoretical 7 m brace of FIGS. 25(i) to 25(iii), but with 46 kN initial post-tensioning, where FIG. 26(i) shows the force-displacement hysteresis for the UFPs, FIG. 26(ii) shows the force-displacement hysteresis for the tendons, and FIG. 26(iii) shows the combined force-displacement hysteresis for the UFPs and tendons;

FIG. 27 shows experimental force-displacement hysteresis loops for the self-centring UFP brace of FIGS. 2(i) to 2(v) with an increased level of initial post-tensioning in the tendons;

FIG. 28 shows the backbone curve for the UFP bracing dissipater of FIG. 27;

FIG. 29 is a plot showing tendon force-drift hysteresis for the high tension self-centering UFP dissipater corresponding to FIGS. 27 and 28;

FIG. 30 is a plot showing dissipated energy per cycle and cumulative dissipated energy for the high tension self-centering UFP dissipater corresponding to FIGS. 27 to 29;

FIG. 31 is a plot of corrected area-based hysteretic damping for the high tension self-centering UFP dissipater corresponding to FIGS. 27 to 30;

FIGS. 32(i) to 32(iv) are experimental results for a prototype grooved dissipater for a multi performance brace such as that shown in FIGS. 3(i) to 6(vii), under tensile loading only, where FIG. 32(i) shows force-displacement hysteresis loops, FIG. 32(ii) shows the backbone curve, FIG. 32(iii) shows dissipated energy per cycle and cumulative dissipated energy, and FIG. 32(iv) is a plot of corrected area-based hysteretic damping;

FIGS. 33(i) to 33(iv) are experimental results for a grooved dissipater for a multi performance brace such as that shown in FIGS. 3(i) to 6(vii), under both tension and compression, where 33(i) shows force-displacement hysteresis loops, FIG. 33(ii) shows the backbone curve, FIG. 33(iii) shows dissipated energy per cycle and cumulative dissipated energy, and FIG. 33(iv) is a plot of corrected area-based hysteretic damping;

FIGS. 34(i) to 34(iv) show experimental results for different embodiment prototype mini UFP dampers, where FIGS. 34(i) to 34(iii) are force-displacement hysteresis loops for first, second, and third embodiment mini UFP prototypes under tensile loading only, and FIG. 34(iv) shows backbone curves for the three prototypes under tensile loading;

FIGS. 35(i) to 35(iv) show further experimental results for the prototype mini UFP device corresponding to FIGS. 34(i) to 34(iv), where FIGS. 35(i) to 35(iii) show dissipated energy and hysteretic damping plots for respective the first, second, and third embodiment prototypes of FIGS. 34(i) to 34(iii) under tensile loading, and FIG. 35(iv) shows corrected area-based hysteretic damping for the three prototypes;

FIGS. 36(i) to 36(iv) show further experimental results for the third mini UFP prototype corresponding to FIGS. 34(iii) and 35(iii) under both tension and compression, where FIG. 36(i) shows a force-displacement hysteresis loops, and FIG. 36(ii) shows the backbone curve, FIG. 36(iii) shows dissipated energy per cycle and cumulative dissipated energy, and FIG. 36(iv) shows the corrected area-based hysteretic damping;

FIGS. 37(i) to (xxiii) are schematic views showing exemplary applications and installations of the mini devices described herein, where FIG. 37(i) shows an installation for a new or retrofitted column to footing connection in a building or bridge, FIG. 37(ii) shows an installation for a new or retrofitted steel column to footing connection, FIG. 37(iii) shows rocking column to footing connection, FIG. 37(iv) shows an installation for a new or retrofitted exterior beam-column joint, FIG. 37(v) shows an installation for a new or retrofitted interior beam-column joint, FIG. 37(vi) shows a haunch-type installation for a new or retrofitted external beam-column joint, FIG. 37(vii) shows a haunch-type installation for a new or retrofitted exterior beam-column joint, FIG. 37(viii) shows a haunch-type installation for a new or retrofitted interior beam-column joint, FIG. 37(ix) shows an installation for a new or retrofitted exterior beam-column joint, FIG. 37(x) shows an alternative installation for a new or retrofitted exterior beam-column joint, FIGS. 37(xi) and 37(xii) show two further alternative installations for new or retrofitted interior beam-column joints, FIGS. 37(xiii) and 37(xiv) show two further alternative installations for new or retrofitted exterior beam-column joints, FIG. 37(xv) shows and exemplary installation for a rocking beam-column joint, FIG. 37(xvi) shows mini devices installed as bracing elements in a truss comprising elastic members such as steel or timber members, FIG. 37(xvii) shows an installation in a retrofitted or new multi-column bridge pier, FIG. 37(xviii) shows an installation in a retrofitted or new single-column bridge pier, FIG. 37(xix) shows an installation in a multi-column rocking bridge pier, FIG. 37(xx) shows an installation in a single-column rocking bridge pier, FIG. 37(xxi) shows an installation for non-structural components such as electronic equipment or shelves, FIG. 37(xxii) shows an installation for a heavy non-structural component such as a substation transformer, and FIG. 37(xxiii) shows an installation for a non-structural component such as a merchandise pallet rack;

FIGS. 38(i) and 38(ii) are perspective views showing the mini devices supporting non-structural components, where FIG. 38(i) shows four mini devices supporting a merchandise pallet rack, and FIG. 38(ii) shows mini devices supporting a substation transformer; and

FIGS. 39(i) to 39(x) are schematics showing exemplary applications and installations of the brace devices described herein, either as retrofitted or in a new structure, where FIG. 39(i) shows a diagonal installation of a brace, FIG. 39(ii) shows a chevron installation of two braces, FIG. 39(iii) shows an eccentrically installed brace, FIG. 39(iv) shows a horizontal brace installation, FIG. 39(v) shows an installation in the basement of a structure, FIG. 39(vi) shows a double-damper chevron installation in a multi-story building, FIG. 39(vii) shows a single-damper chevron installation in a multi-story building, FIG. 39(viii) shows a vertical damper installation in a multi-story building, FIG. 39(ix) shows transverse installation of a brace in a bridge pier, perpendicular to the bridge longitudinal axis, and FIG. 39(x) shows horizontal installation of a brace in a bridge pier, parallel to the bridge longitudinal axis.

### DETAILED DESCRIPTION OF A PREFERRED EMBODIMENT

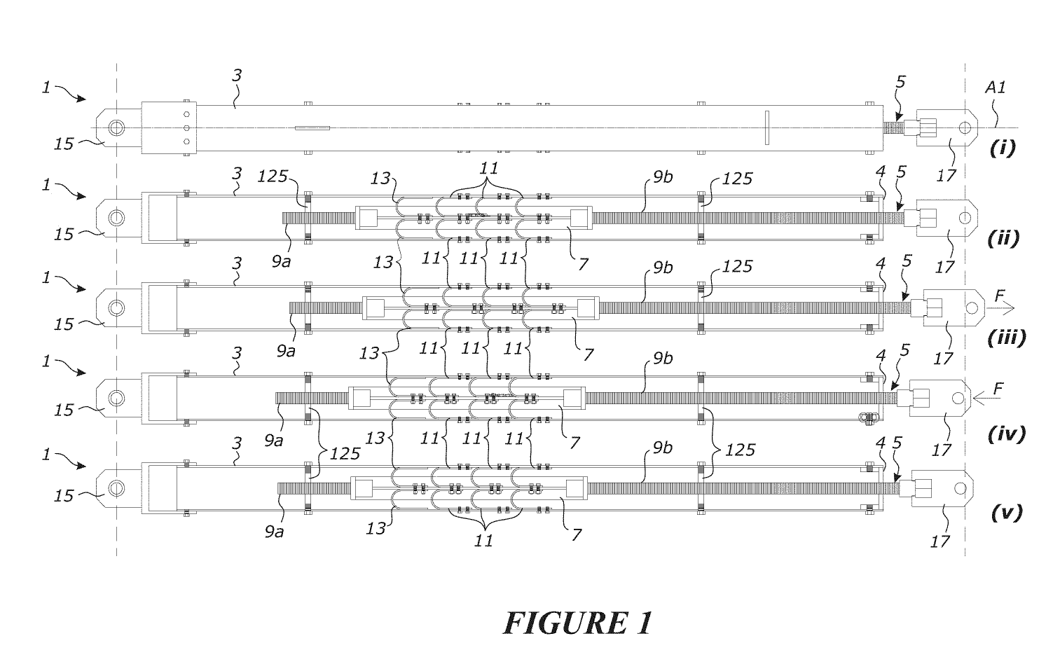

FIGS. 1(i) to 1(v) show an exemplary embodiment energy dissipation device 1 according to an embodiment of the invention. The energy dissipation device 1 is a brace defining a longitudinal axis A1. The brace 1 has a first member 3 and a parallel or coaxial second member 5 that is movable axially along the longitudinal axis A1 relative to the first member 3. A series of U-shaped flexural plates 11 (UFPs) are connected between the first and second members 3, 5, with one side of each UFP 11 bolted to the first member 3 and one side bolted to the second member 5.

One or more redundant UFPs 13 are bolted to the second member 5 only, but not to the first member 3, such that the redundant UFPs 13 move with the second member 5 relative to the first member. Alternatively, the redundant UFPs could be bolted to the first member 3 only, such that the second member moves relative to the redundant UFPs 13.

In the embodiments shown in the drawings, only one pair of redundant UFPs are shown for simplicity. Preferably the number of bolted UFPs is the same as the number of redundant UFPs. That is, the embodiment in FIGS. 1(i) to 1(v) preferably comprises at least 6 redundant UFPs.

The first member 3 is a hollow member such as a square hollow section or a rectangular hollow section. The second member 5 comprises two coaxial threaded rods 9a, 9b, joined by a central section 7 in the form of an I-beam. A major part of the second member 5 is positioned within the hollow of the first member 3. The UFPs 11, 13 are bolted to the web of the I-beam 7. The second member 5 is slidably mounted relative to the first member 3 by guides in the form of bushings 125, which are spaced from the ends of the second member 5. This ensures full functionality can be restored to the brace after a maximum considered earthquake event by connecting all of the redundant UFPs to the first member 3.

The brace 1 has first and second end connectors 15, 17 for attaching the brace 1 between two structural members in a structure such as a building or a bridge. The second end connector 17 is adjustable, for example for installation to reduce the requirement for construction tolerances.

The first end connector 15 is connected to or integral with the first member 3, at a first end of the device 1. The second end connector 17 is connected to the rod portion 9b of the second member 5, which extends beyond the first member 3. In the embodiment shown, the end connectors 15, 17 are lugs for bolting to a structure to form a pinned connection. However, the end connectors 15, 17 may have other forms such as plates for bolting to the structure.

The brace 1 is configured to accommodate axial loading along the longitudinal axis L1 of the device, for example under seismic and wind loadings. FIGS. 1(ii) to 1(v) illustrate operation of the brace 1 during an earthquake. FIG. 1(ii) shows the brace in a neutral position, in which the UFPs 11, 13 are unflexed.

From the neutral position shown in FIG. 1(ii), seismic forces may result in tensile loading of the brace 1, causing the brace 1 to extend as shown in FIG. 1(iii). As the brace 1 extends, the UFPs connected between the first and second members flex, plastically deforming to dissipate energy, permitting relative movement of the first and second members 3, 5.

From the neutral position shown in FIG. 1(ii), or the extended position of FIG. 1(iii), seismic forces may result in compressive loading of the brace 1, causing the brace 1 to compress as shown in FIG. 1(iv). As the brace 1 is compressed, the UFPs connected between the first and second members flex in the opposite direction, plastically deforming to dissipate energy, permitting relative movement of the first and second members 3, 5.

The UFPs 11 attached to the first and second members 3, 5 preferably all have the same dimensions, thickness, and radius, and preferably comprise the same materials such that all of the attached UFPs 11 deform and yield together upon extension or compression of the brace, acting in parallel.

At the end of a seismic event, once all of the energy has been dissipated from the structure, the brace 1 may return to the neutral position shown in FIG. 1(ii), or to a post-loading position such as that shown in FIG. 1(v) in which the brace 1 has some residual displacement. There will be residual displacement in the brace if the tensile and/or compressive forces applied to the brace 1 during the seismic event caused the bolted UFPs 11 to yield. The brace 1 will return to the neutral position shown in FIG. 1(ii) if the UFPs have not yielded such as in a very small earthquake, or if external inertial forces from the structure self-centre the brace 1 by chance.

After the seismic event, one or more of the redundant UFPs 13 bolted to the second member 5 can be bolted or welded to the first member 3 to provide new, un-yielded connections between the first and second members 3, 5. Welding is advantageous if the drilled holes in the redundant UFPs 13 and the one in first member 3 are not aligned after an earthquake, weld metal can be spot welded through the holes in the first member 3 to connect it to the redundant UFPs 13. This advantageously enables the brace 1 to be repaired without removing the brace from the structure and without replacing the entire bracing.

In addition to this ease of repair, the brace of FIG. 1 is cost effective because it can be made from readily available materials. It is also lighter in weight compared to viscous fluid dampers and available buckling restrained braces. Unlike commercially available buckling restrained braces, the brace of the present invention is less susceptible to low-cycle fatigue fracture, has balanced capacity in tension and compression, and is reliable to accommodate large seismic displacements after dozens of large displacement cycles.

The capacity of the UFP brace can be customised by altering the radius, width, thickness and/or the number of bolted UFPs 11.

The length of the brace 1 in FIGS. 1(i) to 1(v) could be substantially shortened without affecting the performance of the brace. The brace 1 is shown at that length for ease of comparison with other embodiments shown in subsequent figures.

Self-Centring Brace

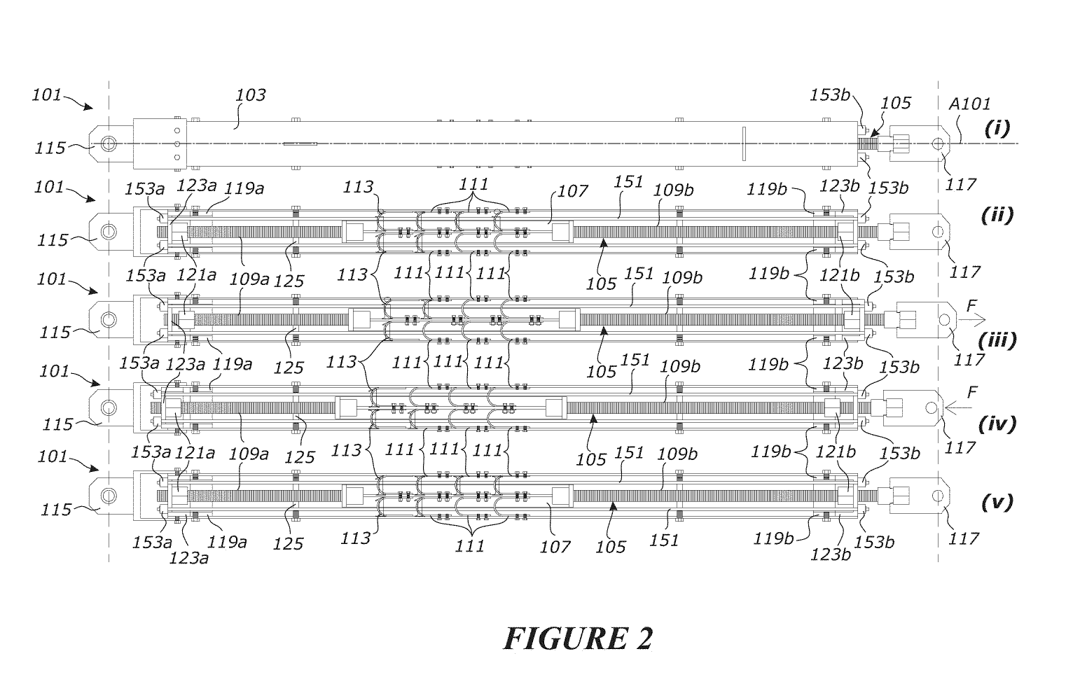

FIGS. 2(i) to 2(v) show an alternative embodiment energy dissipation device 101 according to a second embodiment of the invention. The device 101 is a self-centring brace having a longitudinal axis A101. Unless otherwise specified, the brace components have the same functionality as those described above in relation to the first embodiment brace 1 of FIGS. 1(i) to 1(v), but are designated by like reference numerals with the addition of 100.

The brace 101 comprises first and second movable end caps 123a, 123b that are movable relative to the first and second members 103, 105. A plurality of tendons 151 extend between the two end caps 123a, 123b, and the end of each tendon 153a, 153b is anchored to a respective end cap 123a, 123b. The tendons may be anchored using any known anchoring method. For example, steel tendons may be anchored using a collar and wedge arrangement.

The tendons 151 are initially post-tensioned and configured to be in tension both under extension and compression of the brace 101. The tendons 151 preferably comprise high strength steel, but alternatively may comprise fibreglass, carbon fibre, a shape memory alloy, or other suitable material. In one example, the tendons may comprise bars comprising a specified length of shape memory alloy connected to steel bar through couplers. In this case, when the brace is stretched the steel portion of the bar will not stretch, only the shape memory alloy part stretches. This combined steel and shape memory alloy bar is lower cost than a tendon comprising shape memory alloy only.

The first and second members 103, 105, each have two respective stops 119a, 119b, 121a, 121b that limit inward movement of the end caps 123a, 123b. The stops 119a, 119b on the first members 103 are shoulders that protrude inwardly from the walls of the square hollow section. The stops 121a, 121b on the second member 105 are nuts threaded onto the second member rods 9a, 9b. FIGS. 2(ii) to 2(v) illustrate operation of the second embodiment brace 101 during an earthquake. FIG. 2(ii) shows the brace 101 in a neutral position, in which the bolted UFPs 111 are unflexed. In this position, each movable end cap 123a, 123b is in contact a respective stop 119a, 119b on the first member 103 and a respective stop 121a, 121b on the second member 105.

From the neutral position shown in FIG. 2(ii), seismic forces may cause tensile loading and extension of the brace 101 as shown in FIG. 2(iii). As the brace 101 extends, the UFPs 111 connected between the first and second members 103, 105 flex to dissipate energy, permitting relative movement of the first and second members.

During this tension of the brace 101, the second stop 121b on the second member 105 pushes the second end cap 123b out of contact with the respective stop 119b on the first member 103, while the first stop 119a on the first member 103 prevents the first end cap moving with the second member 105. This increases the distance between the end caps 123a, 123b, tensioning the tendons 151.

From the neutral position shown in FIG. 2(ii), or the extended position of FIG. 2(iii), seismic forces may cause compressive loading of the brace 101, as shown in FIG. 2(iv). As the brace 101 is compressed, the UFPs 111 connected between the first and second members 103, 105 flex in the opposite direction to dissipate energy, permitting relative movement of the first and second members 103, 105.

During this compression of the brace 101 the first stop 121a on the second member 105 pushes the first end cap 123a out of contact with the respective stop 119a on the first member 103, while the second stop 119b on the first member 103 prevents the second end cap 123b moving inwards upon movement of the second member 105. This increases the distance between the end caps 123a, 123b, tensioning and stretching the tendons 151, despite the compressive load applied to the brace 101.

At the end of a seismic event, once all of the energy has been dissipated from the UFPs, the tension in the tendons 151 causes the brace 101 to return to the centred position shown in FIG. 2(v). This re-centring advantageously minimises disruption to the structure following a large earthquake enabling the structure to be functional immediately after the earthquake. This re-centring will happen if the initial post-tension in the tendons is sufficient and provided the relative displacement between the first and second members 103, 105 caused by the seismic event does not cause stretching of the tendons 151 beyond their elastic limit.

The amount of initial post-tensioning required in the tendons 151 to re-centre the brace 101 is a function of the number and capacity of the UFPs 111 that need to be re-centred. Generally, the initial post-tension in the tendons 151 should be at least 1.5 times the force in the UFPs 111 during deflection to re-centre the brace 101. Preferably at least one end anchor 153b of each tendon 151 is externally accessible, enabling the tendons 151 to be post-tensioned without disassembling the brace. This may be necessary for maintenance, or following a seismic event.

The tendons 151 increase the capacity of the brace 101 compared with an embodiment having only UFP dampers. The increase in capacity is a function of the size and number of UFPs and the number, length and gauge of the tendons 151. In one embodiment, the self-centring UFP brace has a capacity twice that of the non self-centring version of FIGS. 1(i) to 1(v) having the same UFP configuration.

Longer tendons advantageously increase the capacity of the brace 101 by increasing the displacement allowable in the brace before the tendons 151 yield. However, longer tendons necessitate a longer second member 105, increasing the risk of the second member 105 buckling under compressive loads. To decrease the buckling length of the second member 105, the second member 105 is slidably mounted relative to the first member 103 by guides in the form of bushings 125 spaced from the ends of the second member 105.

If the relative displacement between the first and second members 103, 105 stretches the tendons 151 beyond their elastic limit, the tendons are unable to fully re-centre the brace 101. In the case of a very high loading causing a large displacement in the brace 101, the tendons 151 may fracture. While this would reduce the capacity of the brace 101, the UFPs would still provide some capacity and prevent collapse of the brace 101.

Multi-Performance Brace

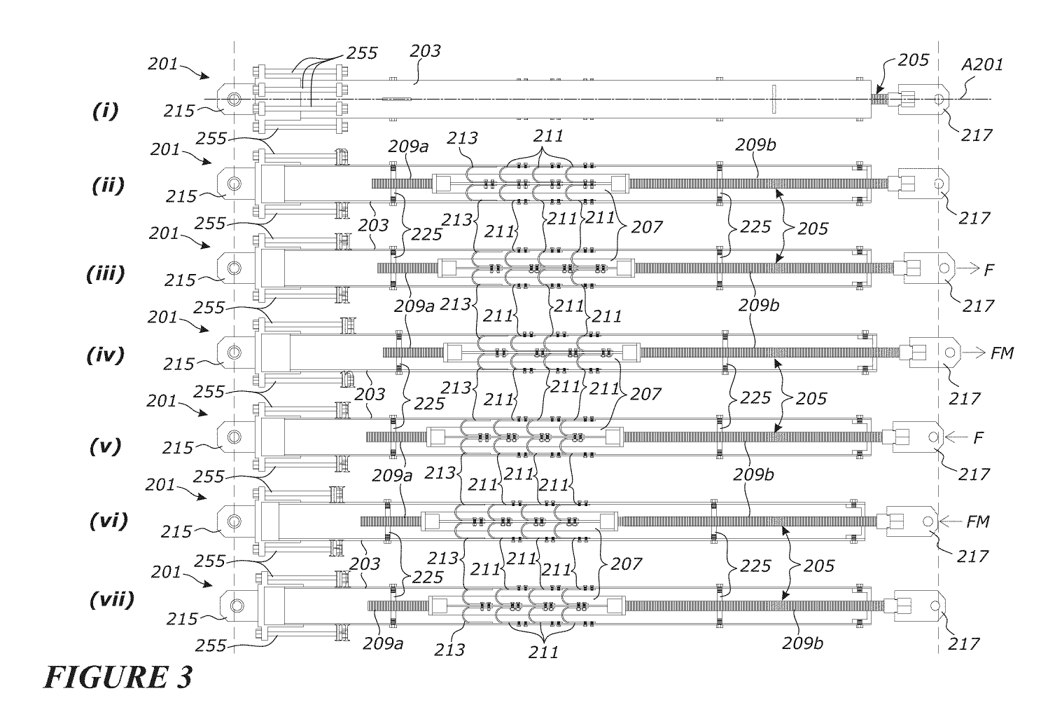

FIGS. 3(i) to 3(vii) show a further alternative embodiment energy dissipation device 201 according to a third embodiment of the invention. The device 201 is a multi-performance brace having a longitudinal axis A201. Unless otherwise specified, the brace components have the same functionality as those described above in relation to the first embodiment brace 1 of FIGS. 1(i) to 1(v), but are designated with like reference numerals with the addition of 200.

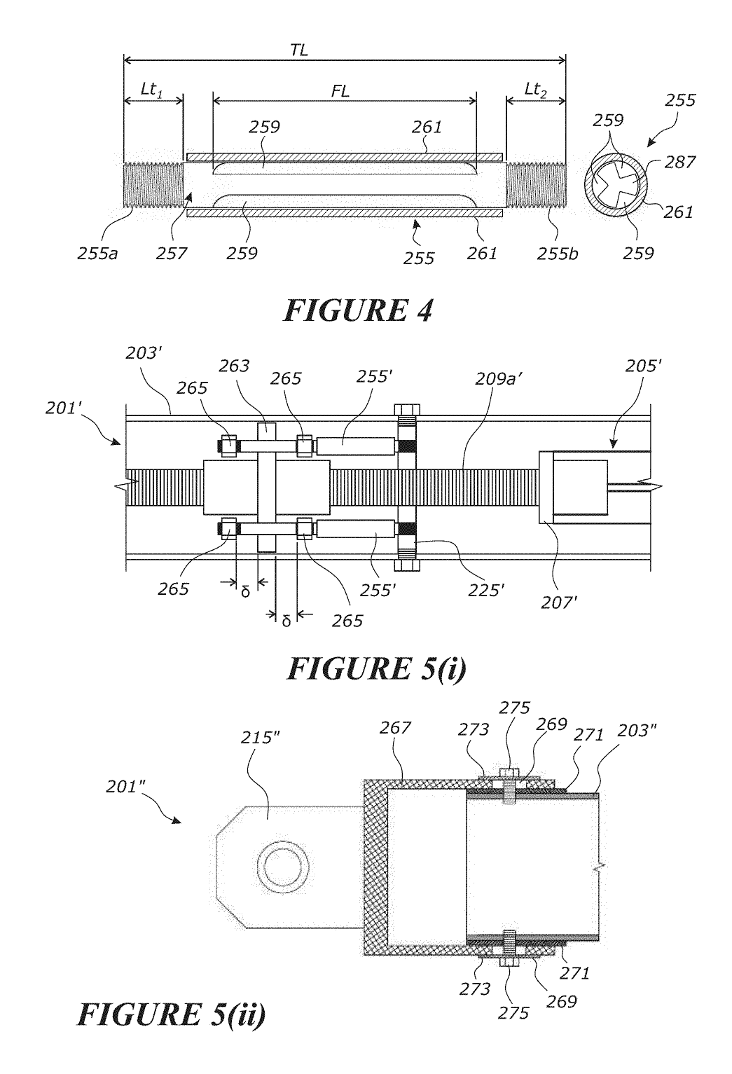

Compared to the brace of FIGS. 1(i) to 1(v), the brace 201 additionally comprises a plurality of supplementary dissipaters 255 at one end of the brace, which offer extra energy dissipation to the UFPs 211 in the brace 201. The dissipaters are preferably grooved dissipaters 255 (FIG. 4). The grooved dissipaters 255 are connected at one end to the first member 203 and at their other end to the end connector 215.

With reference to FIG. 4, the grooved dissipaters 255 comprise mild steel rods 257 having a plurality of grooves 259 along a central portion of the rod 257. The grooves 259 concentrate deformation of the rod 257 within that grooved portion. The rods 257 are positioned within a tube 261 with an inner diameter slightly bigger than the diameter of the rod 257 to prevent buckling of the grooved dissipater 255 in compression.

In one example, the rod 257 has an outer diameter of 24 mm, with three grooves 10.6 mm and 245 mm long. The ends 255a, 255b of the dissipater 255 may be threaded for ease of attachment to the brace 201.

FIGS. 3(ii) to 3(vii) illustrate operation of the multi-performance brace 201 during an earthquake. FIG. 3(ii) shows the brace 201 in a neutral position with the bolted UFPs 211 unflexed, FIGS. 3(iii) and 3(iv) show the brace 201 extended due to tensile loading, and FIGS. 3(v) and 3(vi) show the brace 201 compressed under compressive loading.

The mode of energy dissipation depends on the loading applied to the brace 201, for example, under different level earthquakes.

In the extended position of FIG. 3(iii), a tensile force F causes the UFPs 211 connected between the first and second members 203, 205 to deform to dissipate energy, but the grooved dissipaters are not engaged. However, as soon the demand in the brace 201 exceeds a certain level, the grooved dissipaters 255 will be activated to prevent or minimise damage to the UFPs 211, protecting the integrity of the brace 201. This is illustrated in FIG. 3(vi) where an increased tensile applied force FM causes the grooved dissipaters to activate.

The grooved dissipaters 255 are preferably configured to only engage if the extension of the brace 201 is beyond what the UFPs 211 can accommodate. For example, the grooved dissipaters 255 may engage at a certain level such as the Maximum Considered Earthquake (MCE) but the grooved dissipaters 255 can be adjusted or designed to activate at any desired displacement or force demand in the brace 201.

In the compressed configuration of FIG. 3(v), the UFPs 211 connected between the first and second members 203, 205 are flexed in the opposite direction to dissipate energy and the grooved dissipaters 255 are not engaged. FIG. 3(iv) shows increased compression of the brace under an increased compressive force FM on the brace 201, causing compression of the grooved dissipaters 255. The grooved dissipaters 255 are preferably configured to only engage if the compression of the brace 201 is beyond what the UFPs 211 can accommodate.

At the end of a seismic event, depending on the forces involved, the brace 201 may return to the neutral position shown in FIG. 2(ii) if the loading forces did not cause yielding of the UFPs 211, or to a post-loading position such as that shown in FIG. 2(vii). In the post-loading position of FIG. 2(vii), the brace 201 has some residual displacement caused by plastic deformation of the UFPs and grooved dissipaters 255 if the tensile and/or compressive forces applied to the brace 1 during the seismic event were sufficient to cause yielding of the bolted UFPs 211 and/or the grooved dissipaters 255. If the grooved dissipaters 255 have engaged, there may be additional residual displacement caused by deflections in the grooved dissipaters 255 than if only the UFPs yielded.

In the embodiment of FIGS. 3(i) to 3(v), the grooved dissipaters 255 are positioned externally on the first member 203. This gives the advantage of ease of access for maintenance and replacement. However, alternatively the grooved dissipaters 255 may be provided internally within the hollow of the first member 203, for example as shown in FIG. 5(i).

In the arrangement of FIG. 5(i), the grooved dissipaters 255′ are fixed at one end relative to the first member 203′, for example by being fixed to a bushing 225′. A disk 263 is fixed to the second member 205′ and axially slidable relative to the grooved dissipater 255′ in two directions through distances δ defined by nut fixings 265 or stops on the dissipaters 255′. As the brace contracts and extends, the second member 205′ moves relative to the first member 203′ and the movable disk 263 slides relative to the grooved dissipaters 255′ between the nuts 265. If the displacement of the second member 205′ relative to the first member 203′ exceeds the slidable distance δ, for example under a very large earthquake load, the disk 263 contacts the respective nuts 265 on the grooved dissipaters 255′ to engage the dissipaters. The grooved dissipaters 255′ then act to help dissipate the additional forces and protect the other components in the brace 201 from failure.

Other types of supplementary dissipaters could be used in place of the grooved dissipaters. For example, FIG. 5(ii) shows an embodiment 201″ in which the supplementary dissipater comprises a slotted-bolt connection between the first end connector and the first member. The connection comprises two parallel cap plates 267 fixed relative to the first end connector 215″. The cap plates 267 have aligned slot shaped apertures 269. A washer 273 and bolt 275 arrangement bolts the cap plates 267 to the first member 203″ through the slots 269.

Metal plates 271 such as brass shims are positioned between the cap plates 267 and the first member 203″. The first member 203″ and the friction plates 271 have apertures that correspond to the bolt diameter, for receiving the shank of the bolt. The bolts 275 clamp the plates 271 between the first member 203″ and the cap plates 267 creating a friction connection. As the brace 201″ is stretched or compressed, the bolts 275 will slide longitudinally along the slots 269, dissipating energy by friction, until the bolts 275 hit the end of their respective slot 269. Thereafter, the UFPs will activate to dissipate energy. The friction force in the slotted bolt damper is proportional to the clamping force applied by the bolt 275, and can be adjusted by tightening or loosening the bolt.

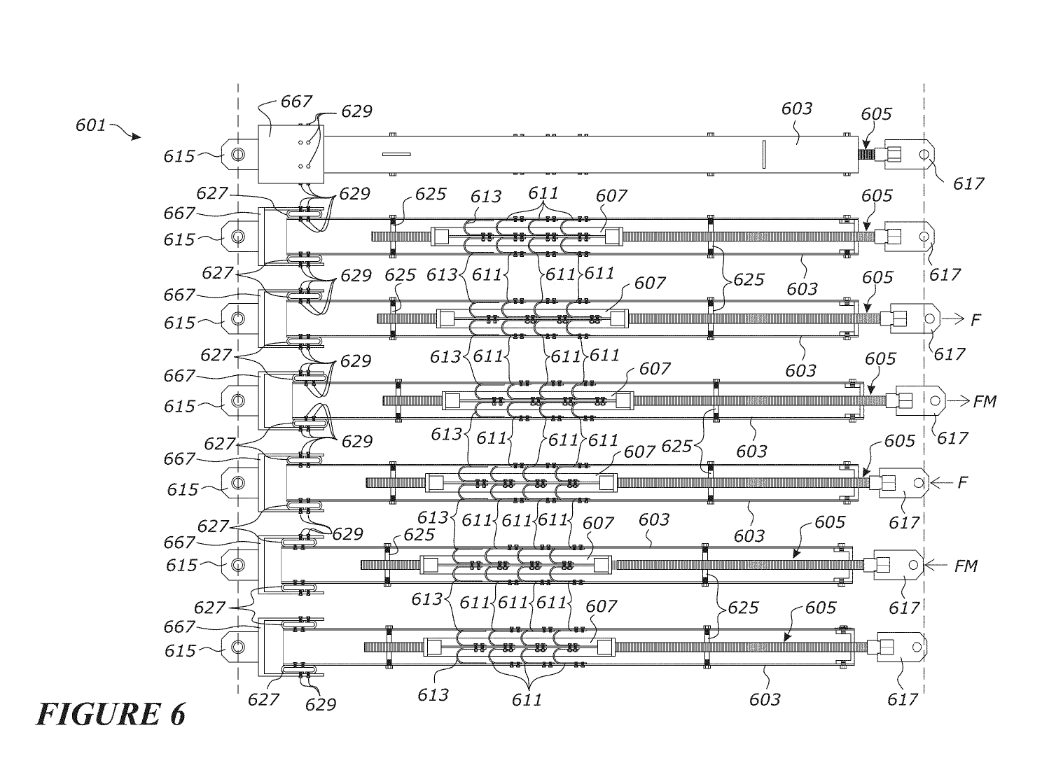

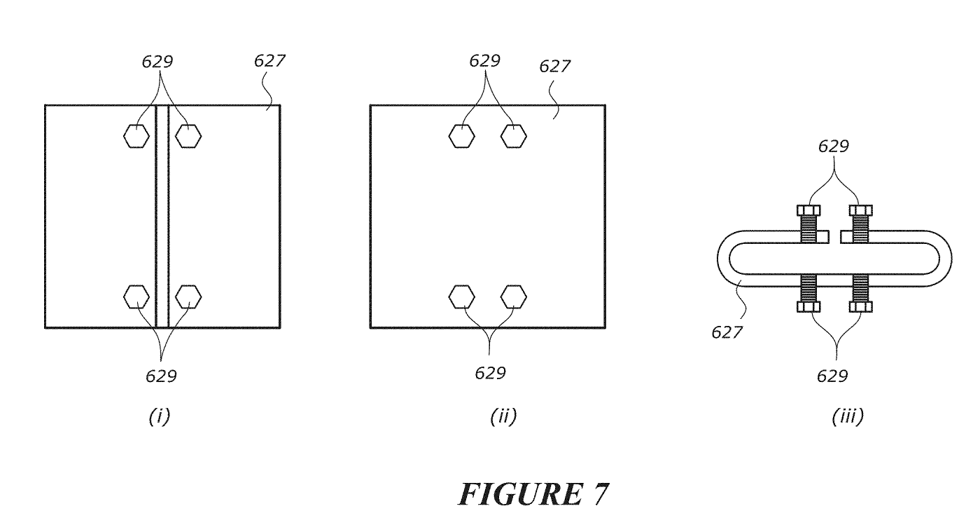

FIGS. 6(i) to 6(vii) show an alternative multi-performance brace embodiment 601. Unless otherwise specified, the brace components have the same functionality as those described above in relation to the embodiment 201 FIGS. 3(i) to 3(vii), but with like reference numerals starting from 600.

Compared to the brace of FIGS. 3(i) to 3(vii), the supplementary dissipaters in the brace 601 comprise a plurality of double UFP dissipaters 627 at one end of the brace 604 in place of the grooved dissipaters 255. The double UFPs 627 are attached with bolts 629 to the first member 603 and to the end connector 615. The double UFPs 627 provide similar functionality compared to the grooved dissipaters 255 in the previous embodiment in that they offer extra energy dissipation to the UFPs 611 in the brace 601.

The thickness, width, and radius of the double UFPs 627 attached to the first end connector 615 are preferably different to those of the internal UFPs 611 on the second member 607 such that they have a larger combined capacity than the internal UFPs 611. The first member 603 will start moving relative to the first end connector, engaging the double UFPs 627 615 as soon as the internal UFPs 611 reach their force or displacement limits (FIGS. 6(iv) and 6(vi)).

FIG. 6(vii) shows that if the load is removed, the brace 601 does not re-centre and has residual displacement due to yielding from both the internal UFPs 611 on the second member 605, and yielding of the double UFPs 627 on the first end connector 615.

As a further option, instead of connecting supplementary UFPs between the first member 603 and the end connector 615, UFPs could be attached externally to one end of the brace 601.

The supplementary dissipaters could alternatively be configured such that they activate before the internal UFPs connected between the first and second members. This would mean only the supplementary dissipaters would engage during after a minor loading event, and the internal UFPs could be configured to yield in a maximum considered earthquake event.

Self-Centring Multi-Performance Brace

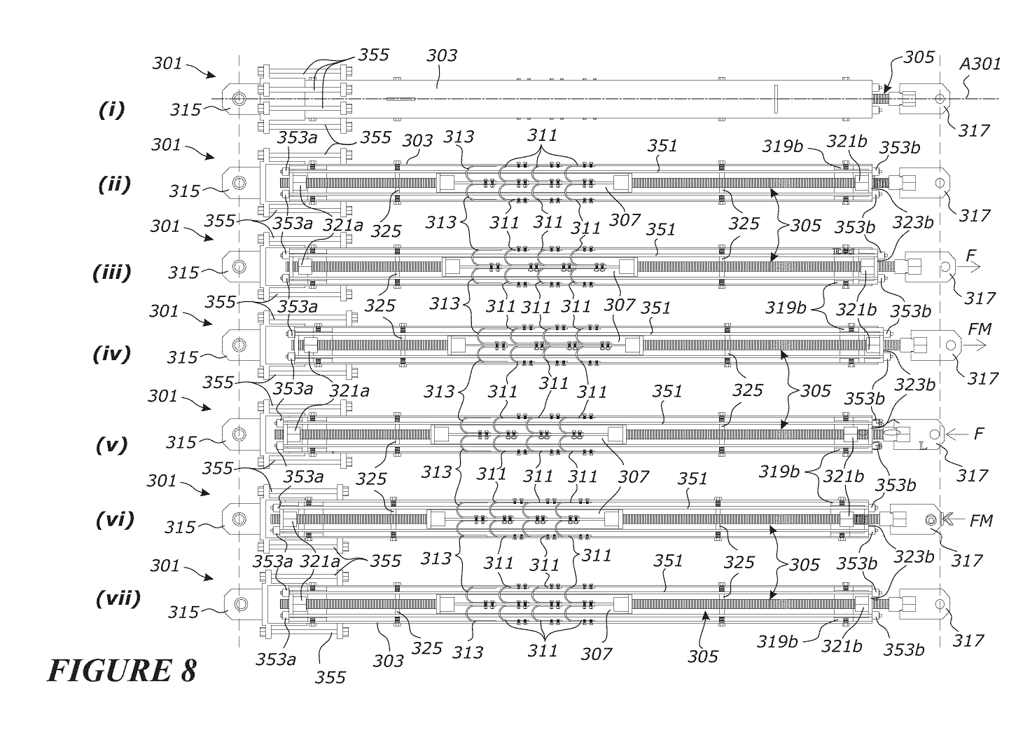

FIGS. 8(i) to 8(vii) show a further alternative embodiment energy dissipation device 301 according to a fourth embodiment of the invention. The device 301 is a self-centring multi-performance brace having a longitudinal axis A301. Unless otherwise specified, the brace components have the same functionality as those described above in relation to the embodiments of FIGS. 1(i) to 3(vii), but are designated with like reference numerals starting from 301.

Compared to the self-centring brace 101 of FIGS. 2(i) to 2(v), the brace 301 additionally comprises a plurality of supplementary dissipaters 355 at one end of the brace 301. The supplementary dissipaters are grooved dissipaters 355 as described above in relation to the multi-performance embodiment of FIGS. 3(i) to 3(vii) and FIG. 4.

The grooved dissipaters 355 cause the brace 301 to behave differently under different level earthquakes and provide extra energy dissipation to the UFPs 311 and tendons 351 in the brace 301 and protects the tendons 351 from yielding or fracture. During an earthquake, the UFPs 311 and tendons 351 will be stretched and start working, but as soon the demand in the brace 301 exceeds a certain level, the grooved dissipaters 355 will activate to prevent or minimise damage to the UFPs 311 and tendons 351 protecting the integrity of the brace.

The brace 301 is preferably configured such that the grooved dissipaters 355 activate before the tendons 351 yield, for example at 60% of yielding, to prevent fracture of the tendons 351.

After loading, the self-centring multi-performance brace 301 will come to neutral as long as the grooved dissipaters 355 have not yielded. If the grooved dissipaters 355 have yielded, there may be residual displacement from grooved dissipaters, but the internal parts will self-centre following an earthquake.

Alternatively, the supplementary dissipaters may comprise supplementary UFPs such as double UFP dissipaters 627 shown in FIGS. 3(i) to 3(vii), or other suitable dissipaters.

Applications

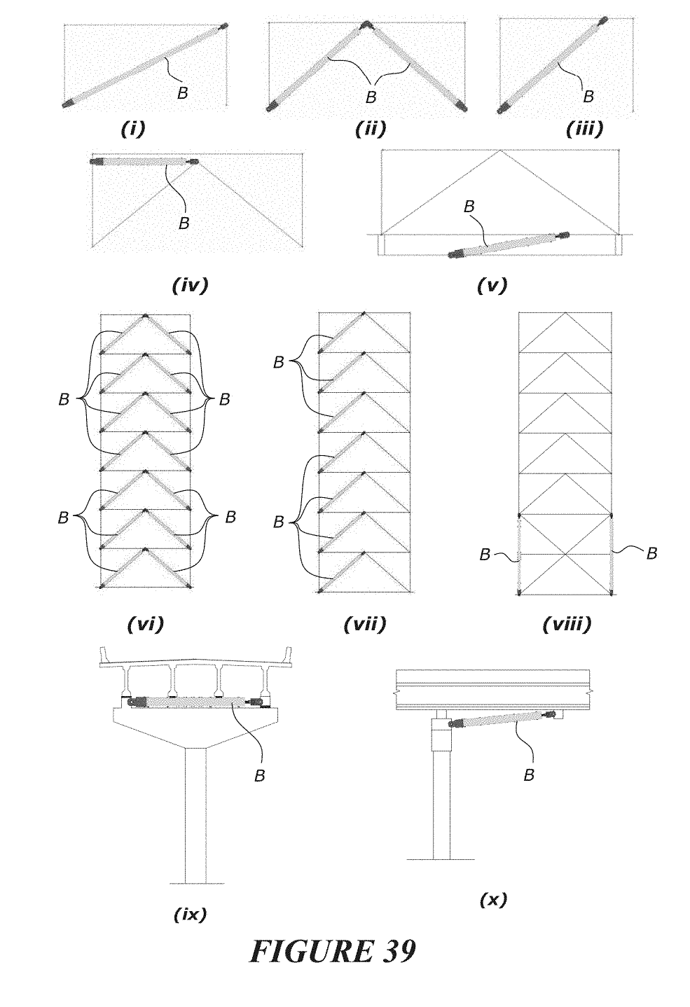

The UFP braces described above and shown in FIGS. 1(i) to 6(vii) can be used in structures such as buildings and bridge structures to provide energy dissipation and lateral resistance against earthquake and wind forces. The braces 1, 101, 201, 301, 601 can also be retrofitted in buildings and bridges of any materials. A schematic of some different installation configurations of the braces B are shown in FIGS. 39(i) to 39(x).

The packaging of the energy dissipation device, with the UFPs housed within the hollow of the first member provides improved aesthetics compared to existing dampers. These improved aesthetics together with the enhanced seismic behaviour make energy dissipaters according to the present invention more attractive than other readily available dissipaters in the market.

Mini UFP Device

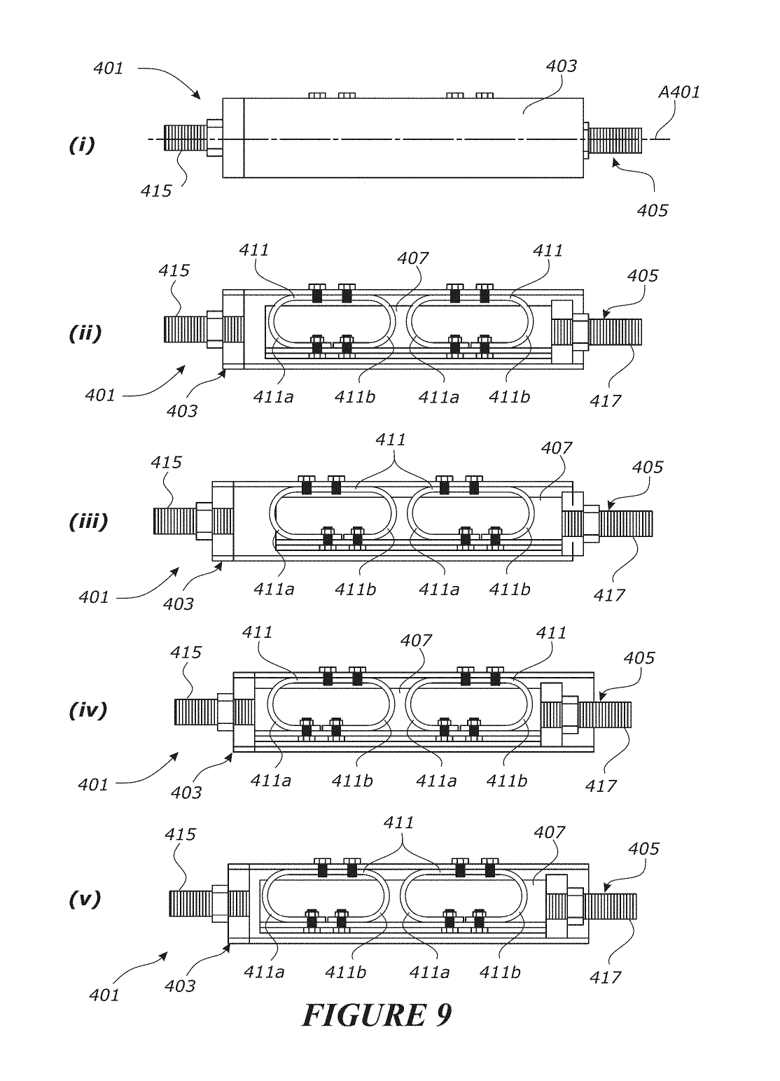

FIGS. 9(i) to 9(v) show a more compact embodiment of the UFP energy dissipation device 401. One embodiment of the device has a longitudinal dimension of about 450 mm. Similar to the previously described embodiments, the mini device 401 defines a longitudinal axis A401, and has a first member 403 and a second member 405 that is movable along the longitudinal axis A401 relative to the first member 403 to accommodate axial loading along the longitudinal axis A401.

Two double UFP dissipaters 411 are each bolted to the first and second members 403, 405. Each dissipater 411 comprises a pair of integral, oppositely oriented U-shaped flexural plates 411a, 411b.

The first member 403 comprises a hollow member such as a square hollow section or a rectangular hollow section, for example, and a threaded end connector 415 for attaching the device 401 to a structural member in a structure such as a building or a bridge. The second member 405 comprises a channel section 407 and a threaded end connector 417. The double UFPs 411 are bolted to the channel 407 and to a wall of the square hollow section 403.

FIGS. 9(ii) to 9(v) illustrate operation of the device 401 during an earthquake. FIG. 9(ii) shows the device 401 in a neutral position, in which the UFPs 411a, 411b are unflexed.

FIGS. 9(iii) and 9(iv) show the device 401 extended and compressed during an earthquake. In the extended position of FIG. 9(iii), the UFPs 411a, 411b in each pair 411 flex in opposite directions to dissipate energy. Similarly, in the compressed position of FIG. 9(iv), the UFPs 411a, 411b in each pair 411 oppositely flex to dissipate energy from compression of the device 401.

At the end of a seismic event, once all of the energy has been dissipated from the structure, the device 401 may return to the neutral position shown in FIG. 9(ii), or to a post-loading position such as that shown in FIG. 9(v) in which the device 401 has some residual displacement. There will be residual displacement in the device if the tensile and/or compressive forces applied to the device 401 during the seismic event caused the plastic deformation of the double UFPs 411.

The capacity of this UFP device depends on the radius, thickness, width and the number of bolted UFPs 411a, 411b or double UFPs.

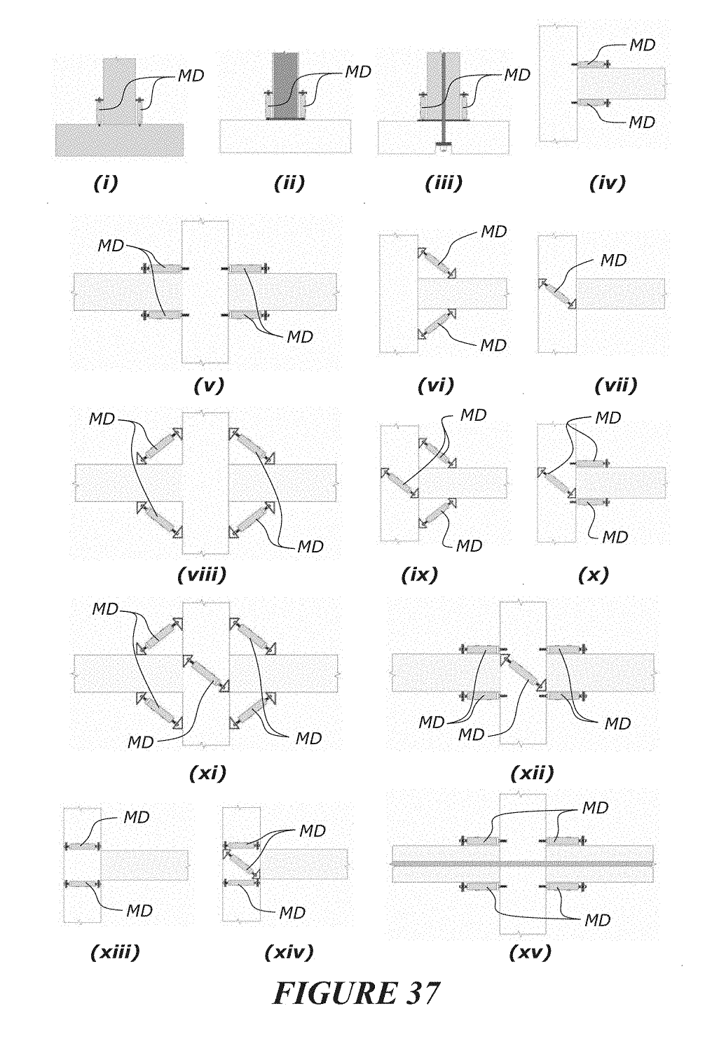

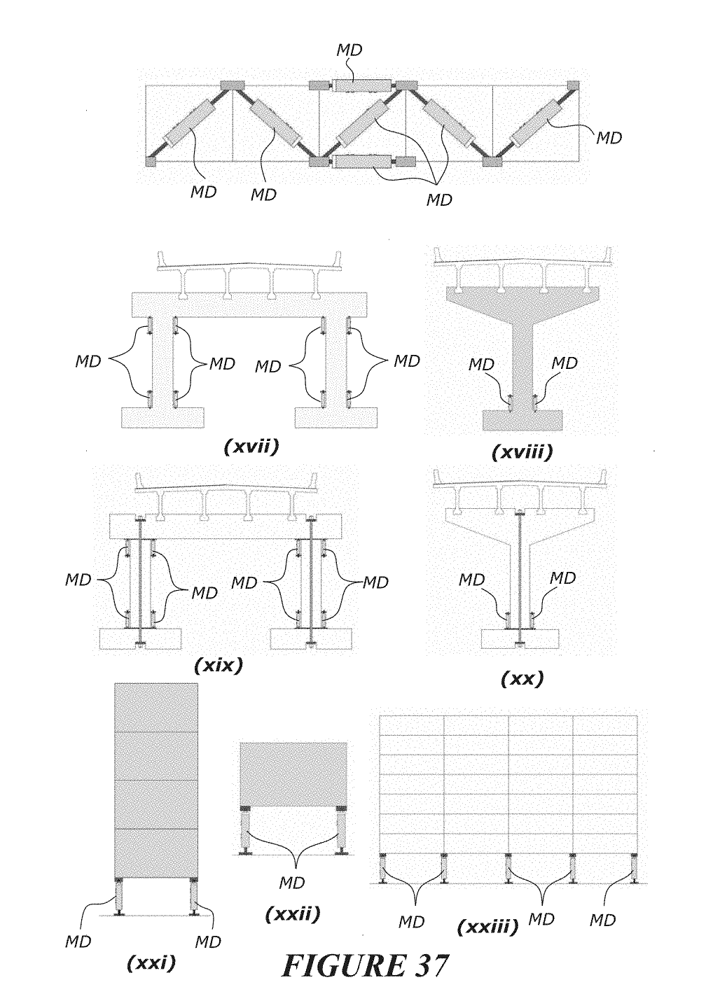

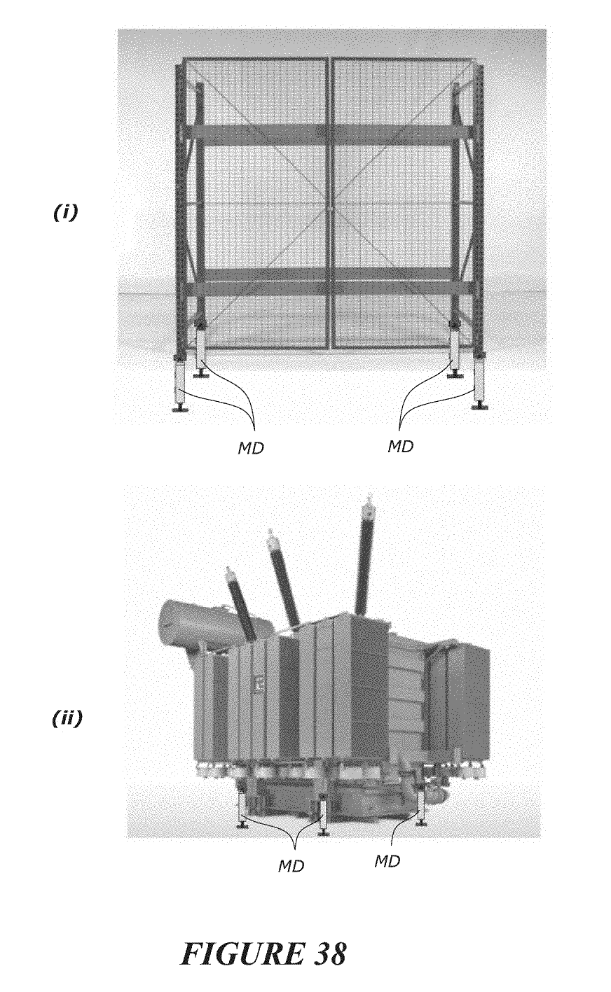

Mini UFP devices such as that shown in FIGS. 9(i) to 9(v) offer similar advantages to those provided by the larger device 101 of FIGS. 1(i) to 1(v). The mini devices are suitable for use in new or existing structures of any material, for example, concrete, steel, or timber. Their compact size makes the mini device 401 particularly suitable for retrofitting beam-column connections, column base connections, or other bracing in existing buildings. Mini UFP devices 401 may also have application in the protection of expensive non-structural components such as medical equipment, machines, substation transformers, and heavy shelves or racks. Some exemplary applications for embodiments of the mini devices MD are shown in FIGS. 37(i) to 37(xxiii), 38(i), and 38(ii).

The double UFPs 411 in the mini UFP device 401 may comprise mild steel, shape memory alloy, or any other type of yielding metal such as aluminium. Instead of double UFPs, the mini device 401 may alternatively comprise a plurality of single UFPs 11.

Alternatively, the dissipaters 411 may comprise shape-memory alloys to provide self-centring functionality. Shape-memory alloys have unique characteristics such as shape memory effects, high damping, and temperature-induced phase change characteristics. For superelastic shape-memory alloys, the nonlinear deformation is reversible unlike other plastically deforming metals such as mild steel.

For example, the dissipaters may comprise a superelastic shape-memory alloy, which displays temperature-induced phase change characteristics, or Nitinol (NiTi) shape-memory alloy, for which the phase change can be stress-induced at room temperature. The material may be selected to have the desired hysteretic behaviour, for example flag-shaped hysteretic behaviour.

In some embodiments of the mini dampers self centring of the device may be provided with stiff springs or post-tensioned tendons arranged in series with ring springs to control yielding of the tendons.

In addition to providing self-centring, embodiments having shape-memory alloy UFPs advantageously provide highly reliable energy dissipation based on a repeatable solid state phase transformation, flag-shaped hysteretic damping, excellent low and high-cycle fatigue properties, and excellent corrosion resistance.

If necessary, the capacity of the mini device 401 can be significantly increased by increasing the thickness of the double UFPs 411, without any changes to the overall external dimensions of the device 401.

Multi-Performance Mini UFP Device

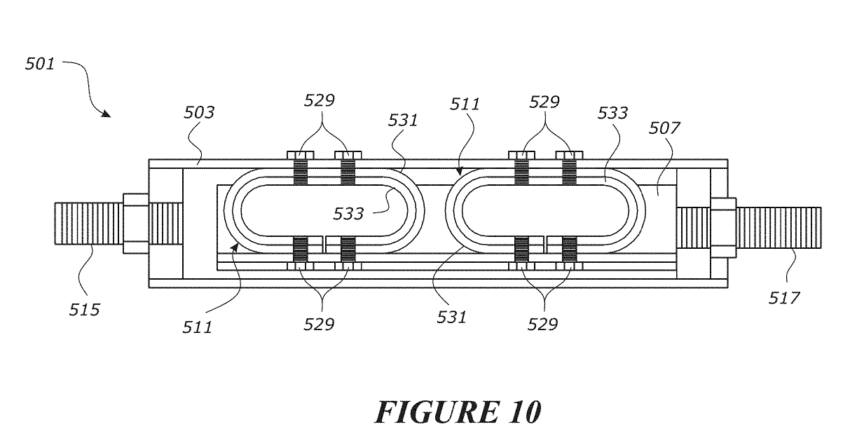

FIG. 10 shows an alternative embodiment of the device 401 of FIGS. 9(i) to 9(v). The device 501 in FIG. 10 differs in the nature of the double UFPs 511 in the device 501.

Each UFP 511 comprises two UFPs 531, 533 nested one inside the other. The nested UFPs 531, 533 are bolted together to the first and second members 503, 507. This increases the overall capacity of the dissipater 501. The nested UFPs 531, 533 provide redundancy if the inside or outside UFP is fractured after a number of cycles. In such a case, the non-fractured UFP will protect the overall integrity of the dissipater and the connections. This can help minimise low-cycle fatigue issues, which can be problematic for small radius UFPs.

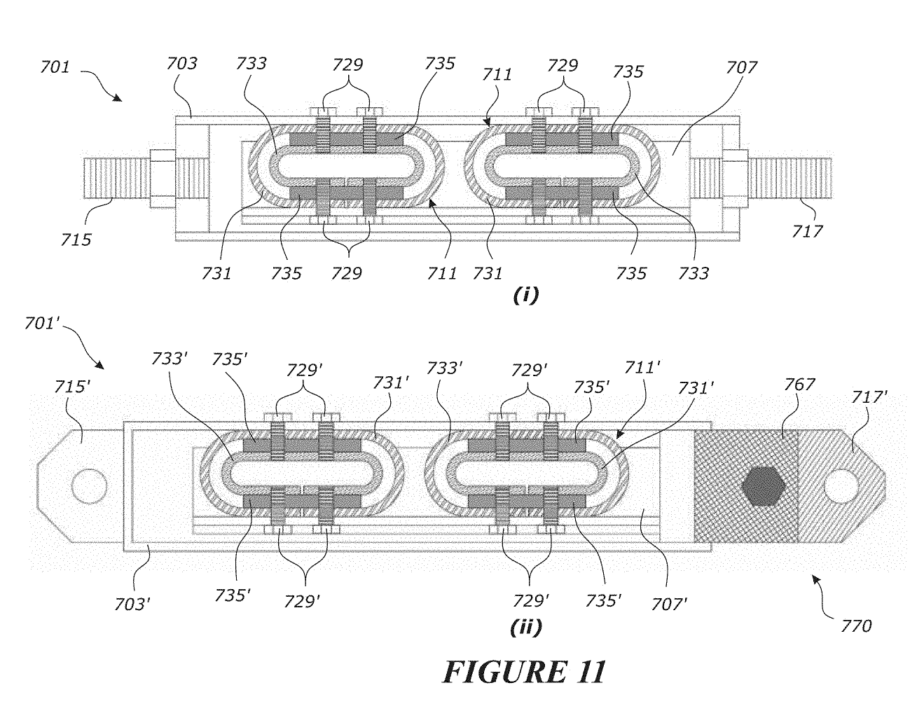

FIGS. 11(i) and 11(ii) show two further alternative multi-performance mini devices 701, 701′ in which spacers 735, 735′ are positioned between the nested double UFPs 731, 733, 731′, 733′. Unless otherwise specified, the components of the mini devices 70′, 701′ have the same functionality as those described above in relation to the embodiment 501 FIG. 10, but with like reference numerals starting from 700 or 700′. The thickness of the UFPs 531, 533, 731, 733, 731′, 733′ can be chosen based on the target capacity and stroke of the device 501, 701, 701′. For example, if the inside double UFPs 533, 733, 733′ and outside double UFPs 531, 731, 731′ have the same thickness and width, the inside double UFPs will have higher capacity than the outer UFPs due to their smaller radius. However, the outside double UFP 531, 731, 731′ will be less susceptible to low cycle fatigue than the internal one 533, 733, 733′. This provides multi-performance and redundancy to the device 501, 701, 701′ such that even if the inside double UFPs 531, 731, 731′ fracture, the outer UFPs 533, 733, 733′ will maintain the integrity of the device 501, 701, 701′ at a reduced capacity.

The spacers 735, 735′ in the embodiments of FIGS. 11(i) and 11(ii) enable a larger difference in the radius of the inner and outer UFPs 731, 733, 731′, 733′. For example, to increase capacity by reducing the radius of the inner UFPs 733, 733′ or to delay low cycle fatigue by increasing the diameter of the outer UFPs 731, 731′.

The embodiment of FIG. 11(ii) shows a mini device 701′ that additionally includes a friction damper 770 at one end of the device. The friction damper 770 comprises a slot and bolt arrangement similar to that described above with respect to the embodiment in FIG. 5(ii), to increase the stroke of the damper 701′.

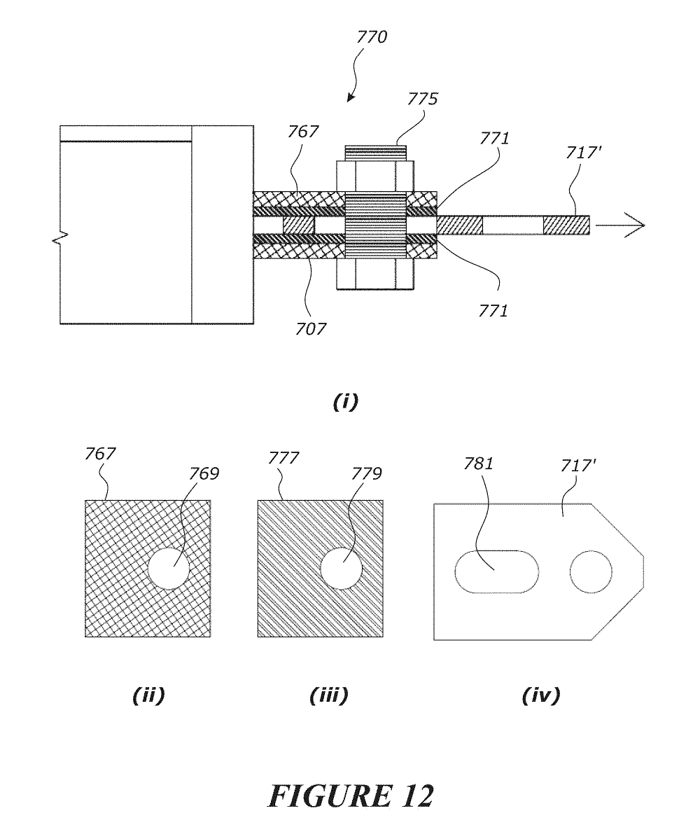

Referring to FIGS. 12(i) to 12(iv), the friction damper 770 comprises two parallel outer plates 767 connected to the second member 707′. An inner plate 717′ forming the second end connector has a slot shaped aperture 781 and is positioned between the parallel outer plates 767. Friction plates 777 such as brass shims are positioned between the inner plate 717′ and the outer plates 767. The outer plates 767 and the friction plates 777 have respective apertures 769, 779, which together with the slot 781 in the end connector 717′, receive a bolt 775.

The bolt 775 is tightened to apply a clamping force between the friction plates and the second end connector plate 717′, creating a friction connection. The friction force is proportional to the clamping force applied by the bolt 275, and can be adjusted by tightening or loosening the bolt 775. The clamping force and thereby the friction force and damping force can be selected such that the friction damper activates before or after the internal UFP arrangements 711′.

For example, if the friction damper 770 is configured to activate before the internal UFP arrangements 711′, as the brace 701′ is stretched or compressed, the bolt 775 will move in the slots 781 to dissipate energy by friction. Once the bolt 775 hits the end of the slot 781, the UFPs arrangements 711 will activate to dissipate energy.

All of the embodiments described above provide the advantage of simple, non-intrusive repair work. The dampers generally will not require any repair work following dozens of design level earthquakes. This minimises life-cycle maintenance costs.

The mini devices can be relatively small and light and do not need a crane to be removed from a structure. After yielding of the UFPs, the mini device may be removed from the structure and the yielded UFPs replaced with new UFPs, while all other parts can be re-used. The device may then be wound back into the structure.

In all of the energy dissipation devices described herein, during displacement of the devices, elastic flexing of the energy dissipater components may initially occur under preliminary loading/displacement so that strain energy is dissipated. Plastic deformation of the energy dissipater components may then occur if sufficient loading/displacement occurs beyond the yield point, so that hysteretic energy is dissipated by the energy dissipation device.

Preferred embodiments of the invention have been described by way of example only and modifications may be made thereto without departing from the scope of the invention.

For example, the number of bolted UFPs and/or the number of redundant UFPs may vary to that shown in the attached figures. Some embodiments of the invention may comprise non-UFP yielding bolted and redundant dampers. For example I- or H-section members.

Relative dimensions of parts in the embodiments shown are for illustrative purposes only and may vary. For example, the devices may be significantly shorter or longer than shown.

Experimental Data

Tests were carried out to establish the performance characteristics and feasibility of various embodiments of the energy dissipating devices, as described below.

UFP Brace

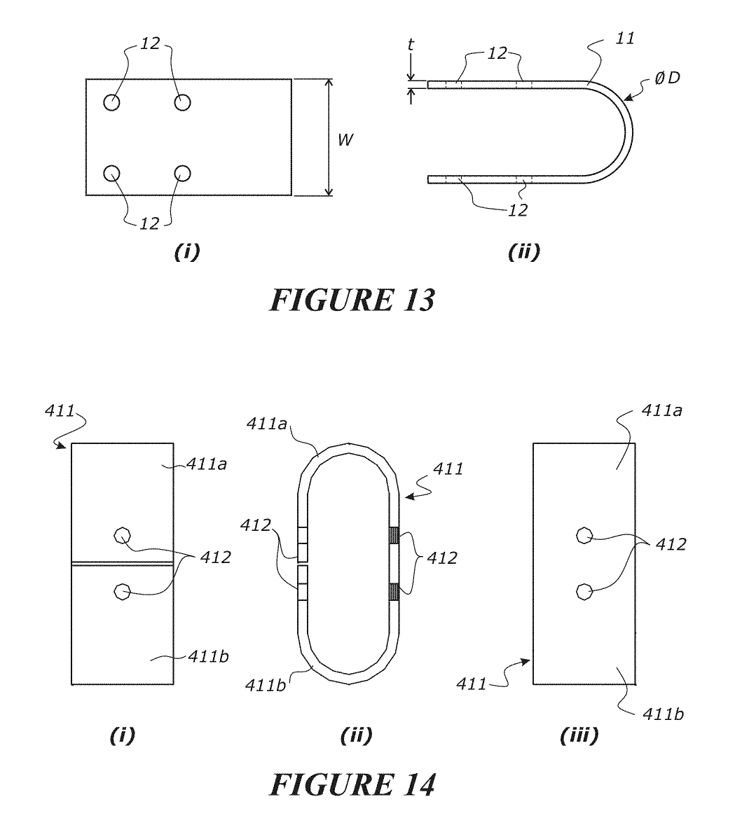

The brace 1 of FIGS. 1(i) to 1(v) was constructed with eight bolted steel UFPs 11, each with 6 mm thickness t (FIGS. 13(i) and 13(ii)), 75 mm diameter D, and 90 mm width, W. The brace 1 was designed for a capacity of 70 kN and had a weight of less than 330 kg.

Testing was carried out using a 10,000 kN Dartec machine. The loading sequence was according to the American Institute of Steel Construction (AISC) Seismic Provisions for structural steel buildings (ANSI/AISC 341-05)—qualifying cyclic tests of buckling-restrained braces. AISC 341-05 prescribes applying loads to the test specimen to produce the following deformations, where the deformation is the steel core axial deformation for the test specimen:
1. 2 cycles of loading at the deformation corresponding to Δb=Δby
2. 2 cycles of loading at the deformation corresponding to Δb=0.50Δbm
3. 2 cycles of loading at the deformation corresponding to Δb=1Δbm
4. 2 cycles of loading at the deformation corresponding to Δb=1.5Δbm
5. 2 cycles of loading at the deformation corresponding to Δb=2.0Δbm
6. Additional complete cycles of loading at the deformation corresponding to Δb=1.5Δbm as required for the brace test specimen to achieve a cumulative inelastic axial deformation of at least 200 times the yield deformation.

Where:

Δb=deformation quantity used to control loading of the test specimen
Δby=Value of deformation quantity at first significant yield of test specimen
Δbm=Value of deformation quantity corresponding to design storey drift

For the UFP damper, Δby was calculated from the UFP geometry (Δby=3.2 mm) according to the method presented by Andrew Baird, Tobias Smith, Alessandro Palermo, and Stefano Pampanin (2014). “Experimental and Numerical Study of U-Shape Flexural Plate (UFP) Dissipators”, Proceedings of 2014 New Zealand Society for Earthquake Engineering Conference, Auckland, New Zealand. Δbm was set to 15 mm. By utilising the procedure outlined in AISC 341-05, the brace was tested for the following loading sequence at a lower speed rate (less than 10 mm/s):
1. 2 cycles of loading at the deformation corresponding to Δb=3.2 mm
2. 2 cycles of loading at the deformation corresponding to Δb=7.5 mm
3. 2 cycles of loading at the deformation corresponding to Δb=15 mm
4. 2 cycles of loading at the deformation corresponding to Δb=22.5 mm
5. 2 cycles of loading at the deformation corresponding to Δb=30 mm
6. 8 cycles of loading at the deformation corresponding to Δb=22.5 mm

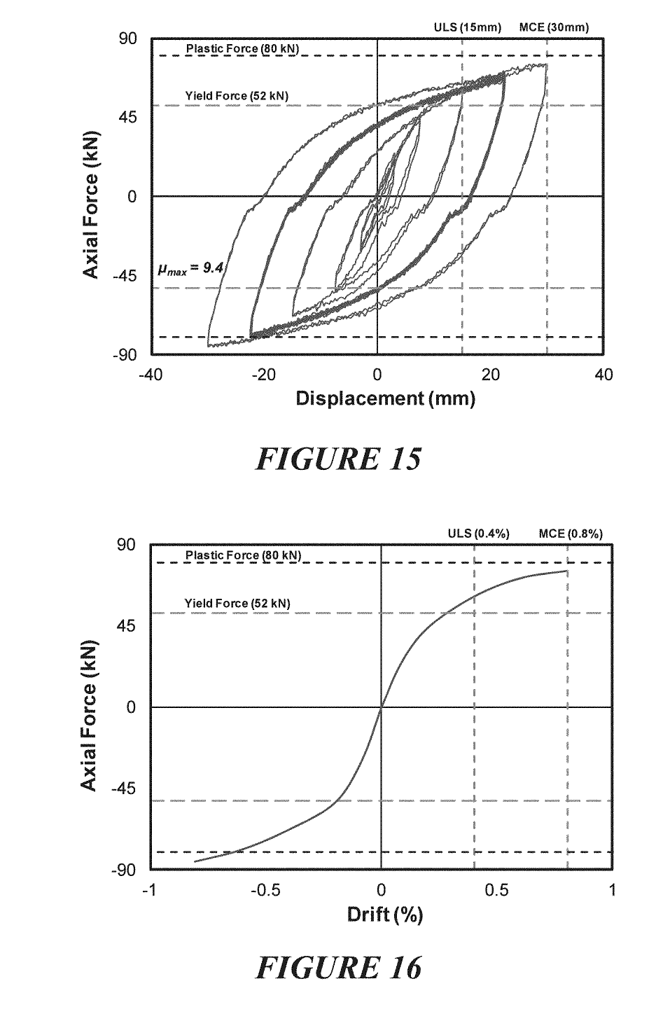

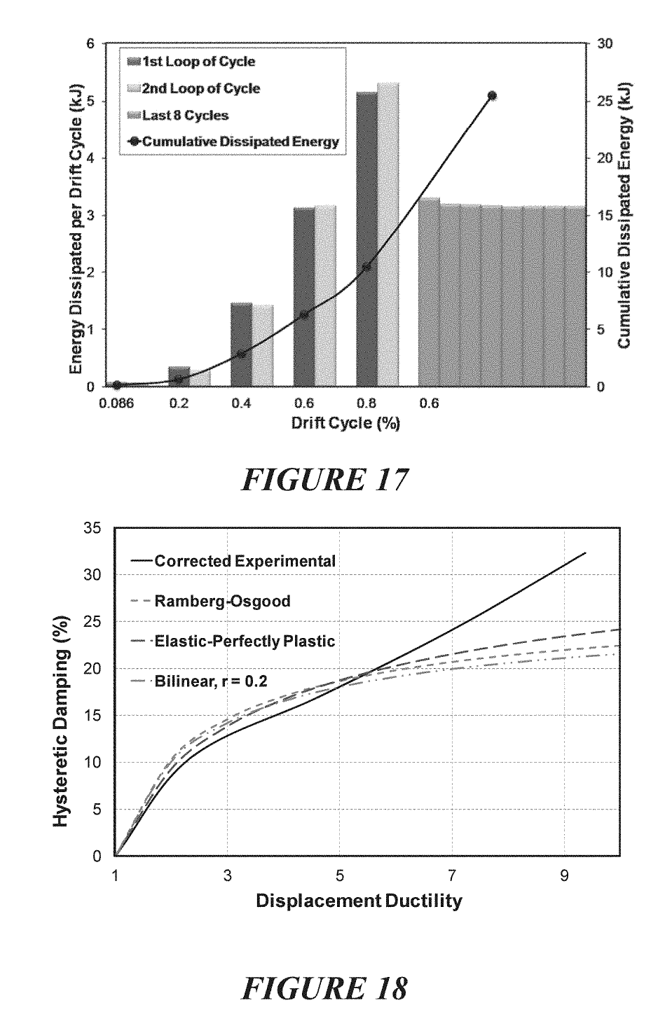

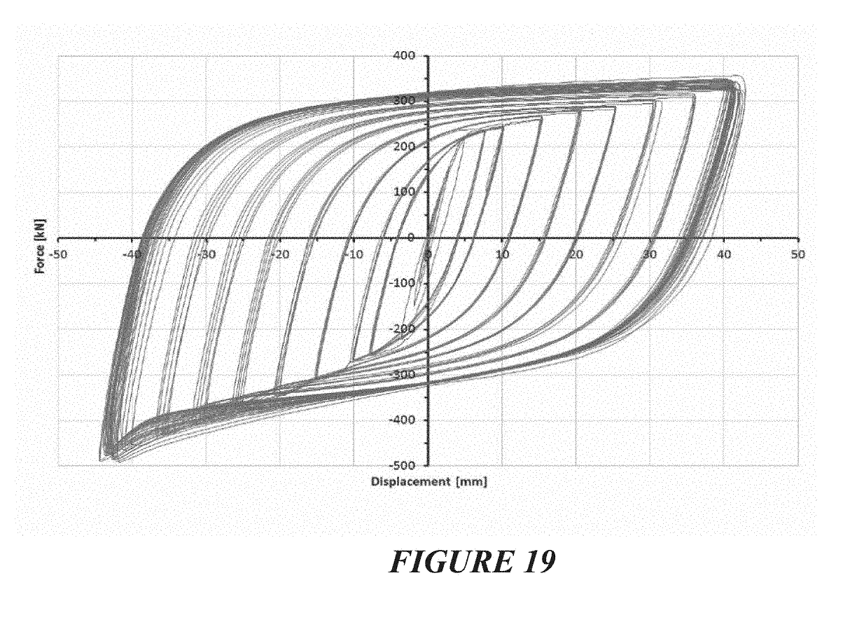

FIGS. 15 to 18 give experimental results for the prototype UFP brace. The UFP brace 1 performed very well with almost no degradation, and very stable force-displacement hysteresis. The UFP brace 1 satisfied all of the testing criteria outlined in AISC 341-05 for buckling restrained brace (BRBs). FIG. 19 also gives force-displacement hysteresis, but for a conventional buckling restrained brace for comparison (Dunai L., Zsarnoczay A., Kaltenbach L., Kallo M., Kachichian M., and Halasz A., 2011 “Type testing of Buckling Restrained Braces According to EN 15129 EWC800 Final report”, Department of Structural Engineering, Budapest University of Technology and Economics).

FIG. 19 shows that in compression, the corners of the hysteresis loop are not smooth and the BRB damper is not balanced; that is it is stronger in compression and weaker in tension. The UFP brace 1 displays stable hysteresis with balanced tension and compression and no degradation after many cycles. This is because UFPs have good performance for low cycle fatigue compared with conventional BRBs. Smoother hysteresis means that the device can be modelled easily using numerical procedures.

At the end of testing, there was a residual displacement of 16 mm in the UFP brace 1, which required a force of 52 kN to re-centre the brace. Alternatively, the brace could be returned to the initial neutral position by unbolting the UFPs and allowing the second member to move relative to the first member. From a seismic performance perspective, the non-centring UFP brace 1 offers advantages as described above, over other non-centring dampers in the market, such as BRBs.

Self-Centring Brace

The brace 101 of FIGS. 2(i) to 2(v) was similarly constructed with eight bolted steel UFPs 11, each with 6 mm thickness, 75 mm diameter, and 90 mm width. The brace included four high strength steel tendons 151, 3200 mm long and having a diameter of 12.7 mm.

The ratio of axial force provided by the tendons divided by the axial force of the combined UFPs (the re-centring ratio), is preferably about 1.5 to achieve full re-centring of the device at a design displacement level. Given a re-centring ratio, the initial post-tensioning force in the tendons can be calculated. For displacements above the design level displacement, the re-centring ratio will be higher at those particular displacements because the tension in the tendon will increase with further displacement to increase the overall brace capacity.

To show how initial post-tensioning affects the capacity of the brace 101, tests were carried out with two different levels of initial post-tensioning in the tendons 151. A re-centring ratio greater than 1.5 was imposed at the design displacement level.

For the first test, the total initial post-tensioning force in all four tendons 151 was equal to 58 kN. This equates to an initial post-tensioning force of 14.5 kN per tendon. This force corresponds to almost 10% of the yielding force for the tendon 151. The capacity of the brace 101 was set to 450 kN at the design displacement (22.5 mm). The re-centring ratio (force in tendons 151/force in the UFPs 111) was 4 (high re-centring) at the design displacement of 22.5 mm.

Calculations for initial post-tensioning in the tendons need to account for post-tensioning losses (due to friction, anchorage loss, relaxation etc), these are part of the design process for the brace.

The testing loading sequence for the centring brace 101 was similar to that from AISC 341-05 used for the non-centring UFP damper 1:
1. 2 cycles of loading at the deformation corresponding to Δb=3.2 mm
2. 2 cycles of loading at the deformation corresponding to Δb=2.5 mm
3. 2 cycles of loading at the deformation corresponding to Δb=5 mm
4. 2 cycles of loading at the deformation corresponding to Δb=7.5 mm
5. 2 cycles of loading at the deformation corresponding to Δb=10 mm
6. 8 cycles of loading at the deformation corresponding to Δb=22.5 mm

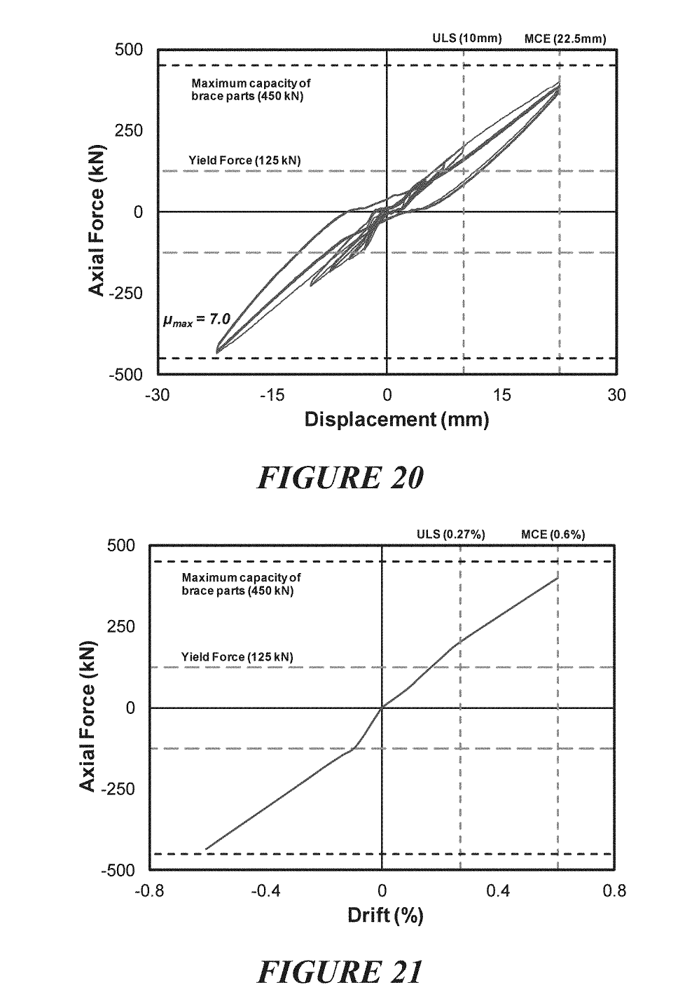

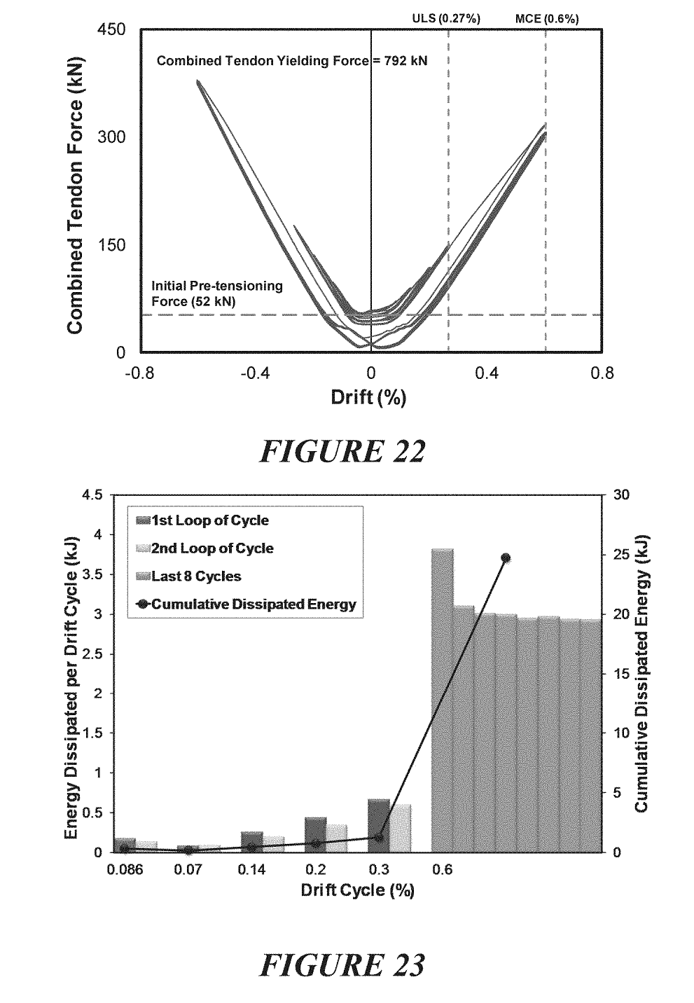

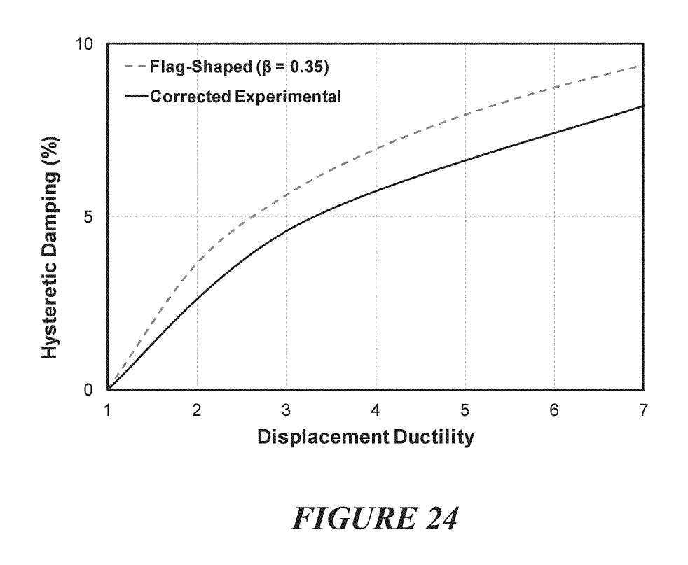

FIGS. 20 to 24 give experimental results for the first prototype self-centring brace 101. The resultant axial load-displacement plot for the brace 101 is shown in FIG. 20. The brace 101 performed well with almost negligible strength degradation and very stable force-displacement hysteresis. The brace satisfied all of the testing criteria outlined in AISC 341-05 for the BRBs, with the flag-shaped hysteresis visible from the force-displacement plots.

At the end of the test there was less than 5 mm residual displacement. The level of force (initial post-tensioning) in the tendons 151 had dropped because the force in the tendons was insufficient to overcome the capacity of the UFPs during the last steps of unloading. The drop in tendon tension is a result of inadequate initial post-tension to re-centre the UFPs during last steps of unloading process. This problem can be addressed by increasing the initial post-tensioning in the tendons to a level that can overcome the capacity of the UFPs during unloading.

The reduced energy dissipation represented thin hysteresis or smaller enclosed area in FIG. 20 is a result of using a high re-centring ratio of 4 at the design level. In practice, a design displacement of 22.5 mm would require a brace twice as long as the one tested, with tendons twice as long as 3200 mm. A longer brace would make it easier to enhance the dissipation capacity by using lower initial post-tensioning in the tendons but ensuring the post-tension is sufficient to overcome the UFPs strength, thereby eliminating residual displacement during the last steps of unloading. It may also be possible to reduce the number of tendons for a longer brace.

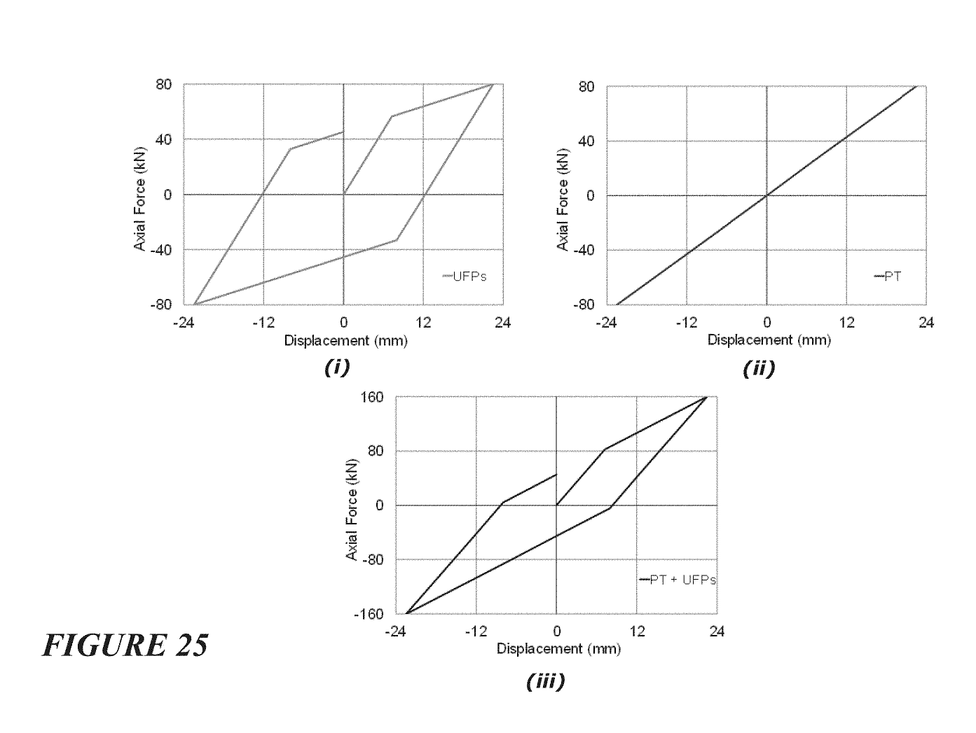

To illustrate these characteristics and the effect of re-centring on the area enclosed inside a flag-shape hysteresis, FIGS. 25(i) to 25(iii) show theoretical force-displacement plots for a 7 m long brace. The brace is modelled with a re-centring ratio of 1.0 at a design displacement of 22.5 mm, UFPs having a total capacity of 80 kN, one 12.7 mm diameter high strength tendon (yield strength of 1560 MPa and yield force of 198 kN), and zero initial post-tensioning in the tendon.

The force-displacement hysteresis of the UFPs in FIG. 25(i) shows a residual displacement of around 12 mm after a 22.5 mm design displacement half cycle. To overcome this 12 mm residual displacement, a force of around 45 kN is needed to self-centre the brace. This means that the initial post-tensioning for the tendon needs to be at least 45 kN. The force-displacement hysteresis for the tendon FIG. 25(ii) shows zero initial post-tensioning in the tendon. However, the force in the UFPs and the tendon are equal (80 kN) at the design displacement (22.5 mm) giving a re-centring ratio of 1.0 at the design level. FIG. 25(iii) shows the combined UFP and tendon hysteresis. The combined system has a lower residual displacement after the first loading and unloading sequence than that of the UFPs (smaller than 12 mm). However, FIG. 25(iii) shows that the post-tensioning was inadequate for self-centring after unloading because the system does not display an ideal flag-shape hysteresis.

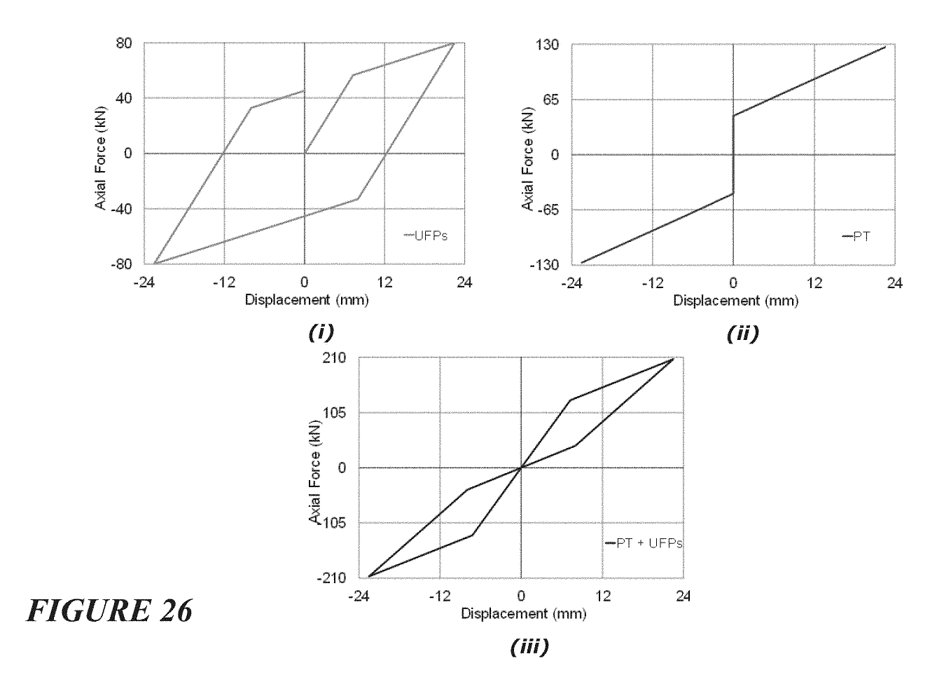

To get an ideal flag-shape hysteresis, the initial post-tensioning force in the tendon of the modelled brace was increased to 46 kN. FIGS. 25(i) to 25(iii) show the resulting force-displacement hysteresis loops. The re-centring ratio at the design level can be easily calculated from the UFPs and tendon hysteresis in FIGS. 26(i) and 26(ii). In this case, the re-centring ratio is 1.625 (130/80). The resultant hysteresis in FIG. 26(iii) (combined UFPs and tendons) has no residual displacement and full re-centring of the brace after a design displacement.

For a second experimental case, to demonstrate full re-centring, the level of initial post-tensioning in the each tendon was increased to 34.5 kN (22% of tendon yielding capacity). Since most parts of the brace 101 were made using readily materials available, the maximum force for parts, fittings, and existing welding connections was set to be less than 500 kN to protect any failure. The maximum displacement for a higher initial post-tensioning force subsequently needed to be less than 22.5 mm. In this case, the displacement was set to 15 mm here for a total of 138 kN initial post-tensioning force in four tendons (34.5 kN/tendon).

The following loading sequence from AISC 341-05 was used for the second test:
1. 2 cycles of loading at the deformation corresponding to Δb=3.2 mm
2. 2 cycles of loading at the deformation corresponding to Δb=3.75 m
3. 2 cycles of loading at the deformation corresponding to Δb=7.5 mm
4. 2 cycles of loading at the deformation corresponding to Δb=11.25 mm
5. 2 cycles of loading at the deformation corresponding to Δb=15 mm
6. 15 cycles of loading at the deformation corresponding to Δb=11.25 mm

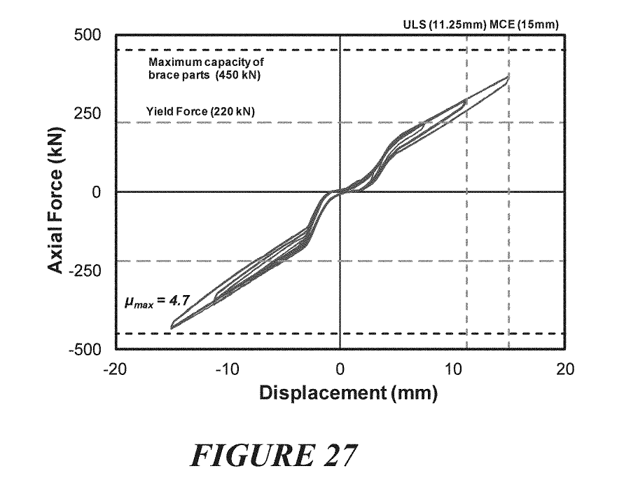

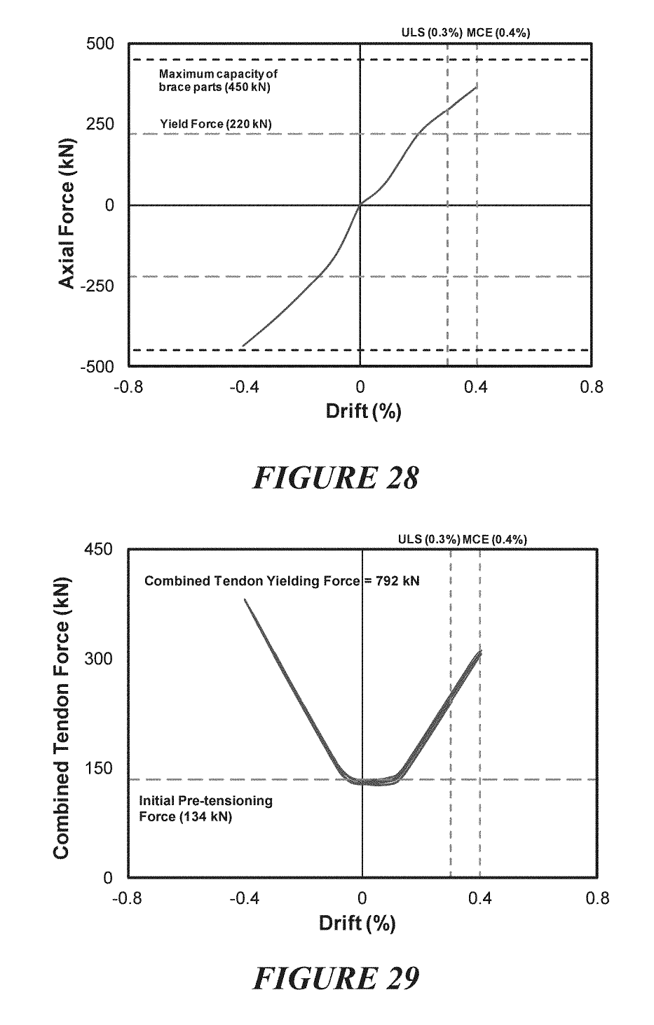

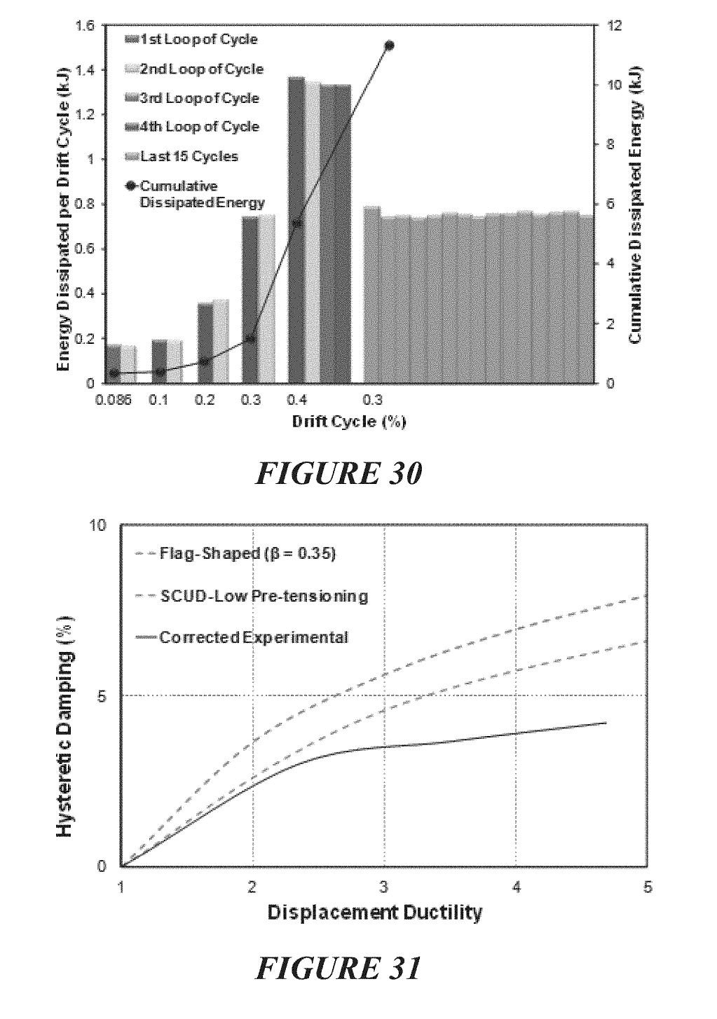

FIGS. 27 to 31 give experimental results for the second prototype self-centring brace 101 with higher initial post-tensioning. The resultant axial load-displacement plots for the self-centring UFP brace 101 are shown in FIG. 27. The brace 101 performed very well with no degradation or failure. The brace fully re-centred, at the end of the test there was zero residual displacement and negligible change in the level of initial post-tensioning in the tendons 151. The flag-shaped hysteresis can be seen in FIG. 27 with a very high re-centring ratio (5) at the design displacement (15 mm). The initial slacking for the first 1 mm of displacement in the graphs is due to construction tolerances of the drilled holes for bolting the UFPs 111 to the first member 103, and slight movement in the parts along the load path. Machined components will improve tolerances and reduce this hysteresis slacking.

Multi-Performance Embodiments

The performance of a grooved dissipater 255, 355 was tested to establish the feasibility of the multi-performance brace embodiments 301, 201. With reference to FIG. 4, the grooved dissipater 255 tested comprised a 24 mm diameter mild steel rod with three 10.6 mm grooves 259, of length FL 245 mm. The grooved dissipater 255 had a total length TL of 435 mm, including a 100 mm first thread length Lt1, and 50 mm second thread length Lt2.

The following loading sequence from was used for the first test for tensile loading only:
1. 3 cycles of loading at the deformation corresponding to Δ1=2 mm
2. 3 cycles of loading at the deformation corresponding to Δ2=3.5 mm
3. 3 cycles of loading at the deformation corresponding to Δ3=6 mm
4. 3 cycles of loading at the deformation corresponding to Δ4=10 mm
5. 3 cycles of loading at the deformation corresponding to Δ5=15 mm
6. 3 cycles of loading at the deformation corresponding to Δ6=25 mm

Where Δ1 is the amplitude of maximum targeted displacement for the first three cycles, Δ2 is the amplitude of maximum targeted displacement for the second three cycles, etc.

The following loading sequence from was used for the second test under both tension and compression:
1. 3 cycles of loading at the deformation corresponding to Δ1=±2 mm
2. 3 cycles of loading at the deformation corresponding to Δ2=±3.5 mm
3. 3 cycles of loading at the deformation corresponding to Δ3=±6 mm
4. 3 cycles of loading at the deformation corresponding to Δ4=±10 mm
5. 3 cycles of loading at the deformation corresponding to Δ5=±15 mm

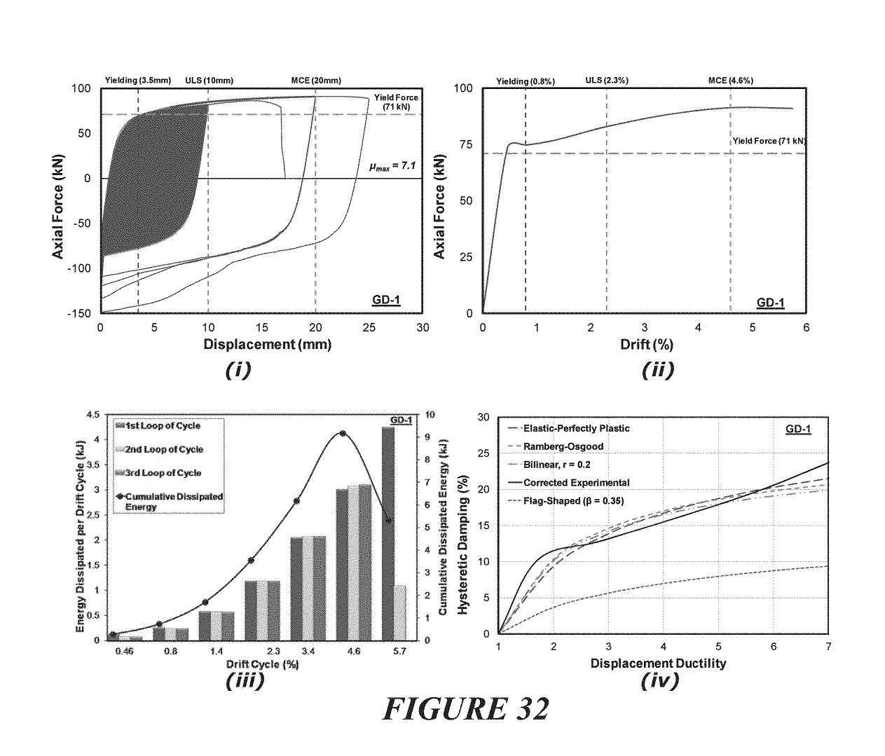

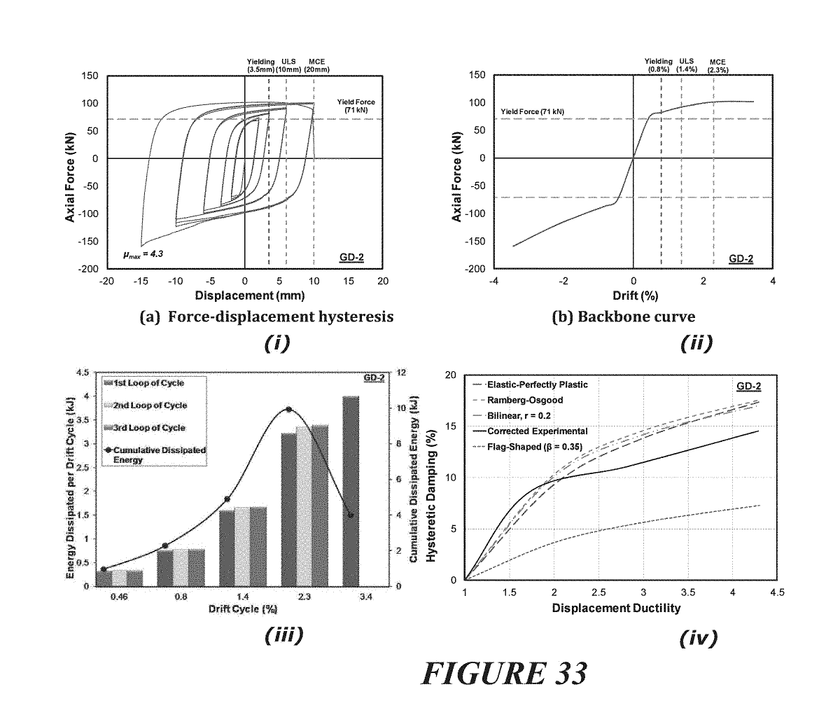

The results for the cyclic testing of the grooved dissipater for the first and second tests are shown in FIGS. 32(i) to 32(iv) and FIGS. 33(i) to 33(iv), respectively. These results show that the force-displacement of the dissipater is very stable. In the first test sequence, the dissipater ruptured after in the second cycle of Δ6=25 mm due to low cycle fatigue. In the second test sequence, the dissipater ruptured in the second half of the first cycle of Δ5=15 mm due to low cycle fatigue.

Mini UFP Brace

Three identical mini UFP brace prototypes similar to the brace 401 of FIGS. 9(i) to 9(v) were constructed for a capacity of 25 kN, with four steel UFPs, each with 5 mm thickness, 50 mm diameter, and 50 mm width. Each mini UFP brace weighed less than 10 kg.

The loading sequences were similar to those described above for the other embodiments.

Each of the three prototypes was subject to a first loading sequence that involved subjecting the brace to a tensile load and then returning it to its initial position. This was carried out at a lower speed rate (1 mm/sec). This sequence may be applicable to applications for the damper in rocking bridge columns:
1. 4 cycles of loading at the deformation corresponding to Δb=2 mm
2. 4 cycles of loading at the deformation corresponding to Δb=5 mm
3. 4 cycles of loading at the deformation corresponding to Δb=10 mm
4. 4 cycles of loading at the deformation corresponding to Δb=15 mm
5. 4 cycles of loading at the deformation corresponding to Δb=20 mm
6. 14 cycles of loading at the deformation corresponding to Δb=15 mm

Δby was calculated from the UFP geometry (Δby=2 mm) according to the method presented by Baird et al. 2014. Δbm was set to 10 mm.

One of the prototypes was subject to a second loading sequence that involved subjecting the brace to tension and then compression. This replicates a very severe loading scenario, applicable to applications where the mini brace is used in tension/compression bracing. The second loading sequence presented involved the following steps:
1. 2 cycles of loading at the deformation corresponding to Δb=±2 mm
2. 2 cycles of loading at the deformation corresponding to Δb=±5 mm
3. 2 cycles of loading at the deformation corresponding to Δb=±10 mm
4. 2 cycles of loading at the deformation corresponding to Δb=±15 mm
5. 2 cycles of loading at the deformation corresponding to Δb=±20 mm
6. 7 cycles of loading at the deformation corresponding to Δb=±15 mm

This second loading sequence was included to show that the mini UFP dampers can work in both compression and tension with similar capacity without any low cycle fatigue.

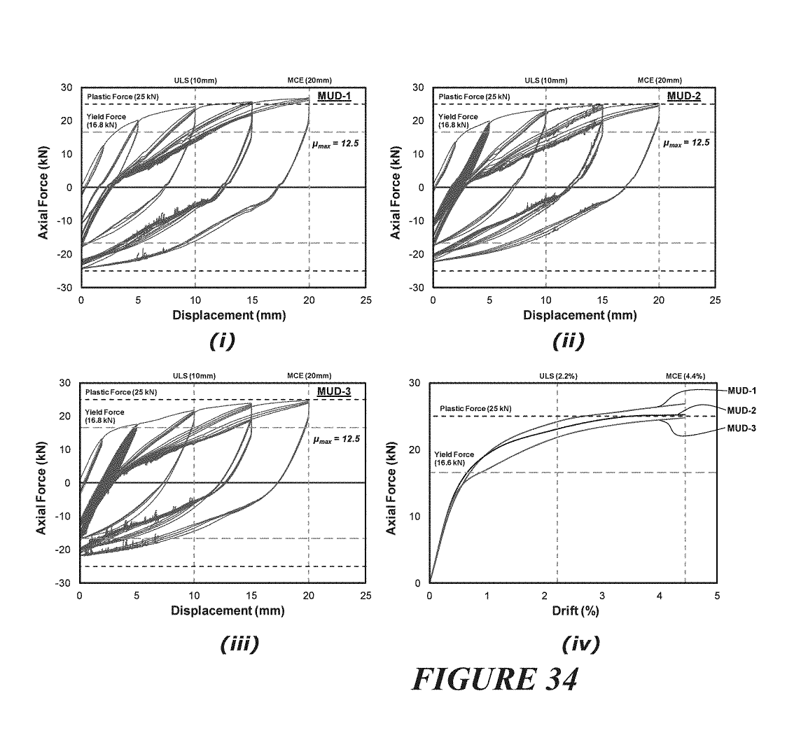

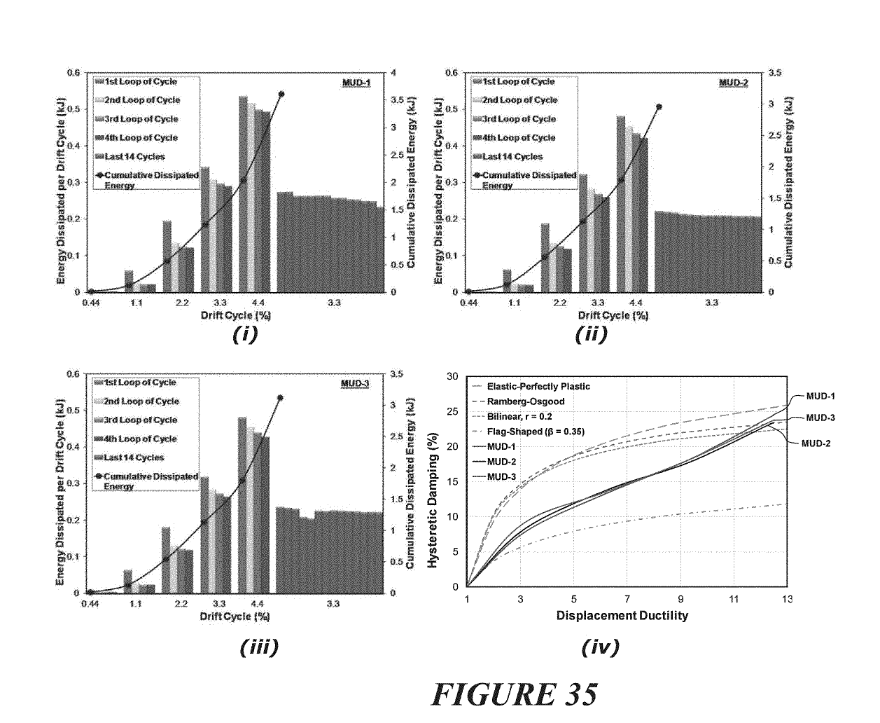

FIGS. 34(i) to 36(iv) give experimental results for the three prototype mini UFP dampers. The three mini UFP prototype dampers performed well and achieved the predicted 25 kN capacity (FIGS. 34(i) to 34(iv)). After the first loading sequence, the braces showed almost zero strength degradation and displayed very stable force displacement hysteresis. All three prototypes satisfied all of the testing criteria outlined in AISC 341-05. At the end of the test, there was a residual displacement of around 18 mm in all of the prototypes. No parts failed prematurely.

In practice, if the mini UFP dampers are used in controlled post-tensioned rocking columns or beam-column joints, then the self-centring can be provided to the dissipaters from the beam/column elastic stiffness or inertial forces from the structure.

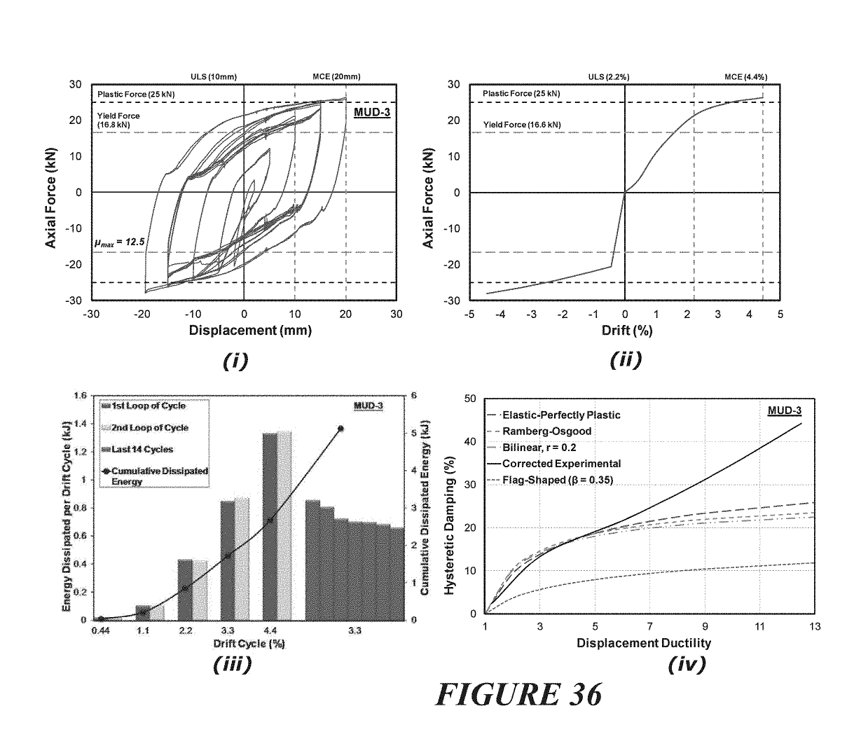

The second loading sequence caused the bolts between the one of the double UFPs 411 and the channel of the second member 405 to fracture and other bolts connected to the UFPs 411 to deform. The force-displacement hysteresis results (FIG. 36(i)) suggest the fracture occurred over the last 7 cycles of loading for the second loading sequence. This did not influence the overall behaviour of the device and can be overcome by using larger diameter bolts, for example M10 bolts.

1. An energy dissipation device having a longitudinal axis, the device comprising first and second members that are movable longitudinally relative to each other upon an axial load applied along the longitudinal axis of the device, and a plurality of U-shaped flexural plates (UFPs) arranged between the first and second members in the longitudinal direction of the device and operatively attached to the first and second members and configured to flex upon relative movement of the first and second members, and one or more redundant UFPs connected to one but not both of the first and second members.

2. An energy dissipation device according to claim 1, wherein the UFPs that are operatively attached to the first and second members are arranged to plastically deform to dissipate energy.

3. (canceled)

4. An energy dissipation device according to claim 1, wherein the first and second members are substantially parallel or coaxial and are movable parallel and/or axially relative to each other.

5. An energy dissipation device according to claim 1, comprising a housing to obscure and protect the UFPs.

6. An energy dissipation device according to claim 5, wherein the housing is provided by the first member, which substantially encloses the second member and the UFPs.

7. An energy dissipation device according to claim 1, wherein the energy dissipation device is a self-centring device.

8. An energy dissipation device according to claim 7, comprising a plurality of post-tensioned tendons, wherein the tendons are coupled to the first and second members such that both compressive and tensile axial loads applied to the energy dissipation device tension and/or stretch the tendons.

9. An energy dissipation device according to claim 8, wherein the tendons are attached to end blocks or end plates that are movable relative to the first and second members, and the first and second members comprise stops that restrict the direction of movement of the end blocks or end plates relative to the first and/or second member.

10. An energy dissipation device according to claim 8, wherein the tendon post-tension is sufficient to bias the first and second members back towards a neutral position upon release of the axial load applied to the energy dissipation device.

11. An energy dissipation device according to claim 1, wherein the energy dissipation device is a multi-performance device, wherein the behaviour of the energy dissipation device varies depending on the magnitude of the axial load.

12-14. (canceled)

15. An energy dissipation device according to claim 11, comprising end connectors at opposite ends of the energy dissipation device, for coupling the energy dissipation device to structural members, wherein the end connectors are removably attachable to the structural member to allow installation, removal and/or replacement of the energy dissipation device.

16. An energy dissipation device according to claim 14, wherein the energy dissipation device comprises at least one supplementary damper operatively connected to the first member, wherein the supplementary damper(s) is/are attached between the first member and an end connector such that the supplementary damper(s) are in series with the UFPs.

17. (canceled)

18. An energy dissipation device according to claim 1, wherein the UFPs that are operatively attached to the first and second members comprise one or more double UFPs, each comprising a pair of integral, opposed UFPs that form an oblong cross-section.

19-22. (canceled)

23. An energy dissipation device having a longitudinal axis, the device comprising: first and second members that are movable longitudinally relative to each other upon an axial load applied to the device; at least one yielding-type energy dissipater operatively attached to the first and second members and configured to flex upon relative movement of the first and second members; and at least one redundant yielding-type energy dissipater connected to one but not both of the first and second members.

24. An energy dissipation device according to claim 23, wherein the yielding-type energy dissipaters are U-shaped flexural plates (UFPs) or have other cross sections such as I- or H-shaped cross sections.

25. An energy dissipation device according to claim 24, wherein the yielding-type energy dissipaters are UFPs.

26. An energy dissipation device according to claim 23, wherein the yielding-type energy dissipaters comprise a ductile material, and are plastically deformable to dissipate energy.

27. An energy dissipation device according to claim 26, wherein the ductile material comprises steel or shape-memory alloy.

28. An energy dissipation device according to claim 23, configured such that if the device is damaged and/or the yielding-type energy dissipater(s) yield under large axial loads, the redundant dissipater(s) can be connected to the other of the first and second members to restore at least some functionality to the energy dissipation device.

29. An energy dissipation device according to claim 23, wherein the energy dissipation device comprises at least as many redundant energy dissipaters as yielding-type energy dissipaters operatively attached to the first and second members.
